(19) United States
(12) Patent Application Publication
(10) Pub. No.: US 2011/0137570 A1
(43) Pub. Date: Jun. 9, 2011

(54) METHODS FOR STRUCTURAL ANALYSIS OF GLYCANS

(76) Inventors: Anthony Lapadula, Hampstead, NH (US); Justin Prien, Rye, NH (US)

(21) Appl. No.: 12/995,388

(22) PCT Filed: May 27, 2009
(86) PCT No.: PCT/US09/45236

§ 371 Date: Feb. 15, 2011

Related U.S. Application Data
(62) Division of application No. 61/057,596, filed on May 30, 2008.
Application No. 61/057,596 is a division of application No. 61/134,440, filed on Jul. 10, 2008.

(51) Int. Cl. G06F 19/16; G06F 19/00

(52) U.S. Cl. 702/19

(57) ABSTRACT

The invention relates to methods useful for the structural analysis of glycans. Methods are disclosed for sequencing glycans using stepwise disassembly processes by analysis of the fragments produced therein. Methods are additionally provided for identifying MSⁿ disassembly pathways that are inconsistent with a set of expected structures, and which therefore may indicate the presence of alternative isomeric structures. A method for interactive spectra annotation is also provided.

### BACKGROUND OF THE INVENTION

The invention relates to methods useful for the structural analysis of glycans. Methods are disclosed for sequencing glycans using stepwise disassembly processes by analysis of the fragments produced therein. Methods are additionally provided for identifying sequential mass spectrometry (MSⁿ) disassembly pathways that are inconsistent with a set of expected structures, and which therefore may indicate the presence of alternative isomeric structures. A method for interactive spectra annotation is also provided.

Glycans include, for example, oligosaccharides that are conjugated to fats (lipids) and to over half of human proteins and other important biomolecules, and play important roles in a wide variety of biological processes. Unlike linear DNA and proteins, glycans are not direct gene products, but instead are synthesized by a step-wise process regulated by numerous enzymes called glycosyltransferases. Therefore, glycan structure cannot be accurately predicted by interpretation of the genetic code and requires sophisticated alternative methods for analysis.

Additionally, glycans are complex branched structures, where one monosaccharide residue may be linked to several others. These linkages also have variables such as linkage position and anomericity, resulting in astonishing numbers of theoretically possible structures. These intrinsic properties make glycan analysis (for example, sequencing or detecting isomeric glycans) a considerable technical challenge.

Glycans are significant in a number of biological and biomedical research areas. For instance, glycans are biomarkers for various cancers and the principal component of new and promising vaccines for diverse cancers, viruses (Dwek et al, Nat. Rev. Drug. Discov., 1: 65-75 (2002)), and bacteria. They drive parasite-host and microbe-host interactions, as well as egg fertilization and protein folding. They are crucial to drug development efforts and are involved in allergic and inflammatory responses. Defective glycan metabolism manifests itself as Congenital Disorders of Glycosylation, Gaucher, Fabry, Tay-Sachs, and Sandhoff diseases, among others. Research in these and related areas is hindered by the lack of effective glycan sequencing tools and methods.

In light of the biological and biomedical importance of glycans, methods useful for the structural analysis of glycans are of considerable utility. Because glycans cannot be amplified as DNA can, glycan sequencing and structural analysis technologies must operate on minute quantities of oligosaccharides. Structural analysis can be augmented with enzymes that cleave glycans in well-defined ways, but these methods are restricted by the limited number of available exo- and endoglycosidases and by the fact that many such enzymes are not completely specific. As such, a need exists for improved glycan sequence tools and methods

### SUMMARY OF THE INVENTION

The invention provides methods useful for glycan structural analysis that employ stepwise disassembly processes. Analysis of the fragments generated by such processes is used, for example, in glycan sequencing and in the determination of isomeric glycans. Stepwise disassembly processes include mass spectrometry (MS) and sequential mass spectrometry (MSⁿ), the sensitivity of which is useful when working with minute analytic samples. The use of mass spectrometry in glycan analysis has largely been limited to the composition of glycan structures as obtaining sequence information has continued to pose considerable technical challenges (Sheridan, Nat Biotechnol. 25: 145-146, 2007). The invention also provides methods of interactive spectra annotation.

In the first aspect, the invention provides a method of glycan sequencing. This method accordingly includes the steps of:
(a) identifying a fragmentation tree of a sample containing one or more glycans using a stepwise disassembly process;
(b) starting the analysis with a terminus of the fragmentation tree, generating possible substructures represented by an experimentally obtained fragmentation value, and predicting a fragmentation pattern of the substructures;
(c) comparing the experimentally observed fragmentation pattern with the predicted fragmentation pattern;
(d) accepting only candidate structures that correspond sufficiently to the experimental data based on the analysis of (c);
(e) identifying the next member of the fragmentation tree and calculating possible compositions that would correspond to this fragmentation pattern;
(f) growing the candidates structures from step (d) to represent possible substructures matching the compositions identified in step (e);
(g) predicting fragmentation patterns of the candidate structures of step (f); and
(h) repeating steps (c)-(e) on the fragmentation patterns of step (g);

where steps (e)-(h) are, optionally, repeated at least once; and

where fragmentation patterns are mapped to a precomputed composition database.

In certain embodiments, steps (e)-(h) are repeated for all precursor spectra or for a subset of precursor spectra in the fragmentation tree.

In other embodiments, the terminus of the fragmentation tree in (b) is the terminal member, the root member, or an intermediate member.

In some embodiments, the possible substructures generated in (b) are all possible substructures or a subset of all possible structures.

In still other embodiments, a scoring method is used to determine acceptable candidate structures. In certain embodiments, the scoring method includes
weighting the bond strengths of bonds ruptured in ionization;
favorably weighting high abundance matching peaks in the experimental data and the predicted fragments for the candidate structure;
penalizing a candidate structure if predicted fragments are missing from the experimental data; and
penalizing a candidate structure if predicted fragments appear in the experimental data with significantly lower abundance than expected.

In some embodiments, the stepwise disassembly process includes sequential mass spectrometry. In particular embodiments, sequential mass spectrometry uses:
an experimental mode that is positive or negative;
an ionization method selected from electron ionization (EI), electrospray ionization (ESI), matrix-assisted laser desorption/ionization (MALDI), surface-enhanced laser desorption/ionization (SELDI); or similar methods.
a dissociation mode selected from collision-induced dissociation (CID), in-source fragmentation, infrared multi-photon dissociation (IRMPD), electron capture dissociation (ECD), electron transfer dissociation (ETD), laser-induced photofragmentation, or similar methods.

In other embodiments, the stepwise disassembly process further includes the use of at least one glycosidase. In further embodiments, the stepwise disassembly process includes
(a) dividing an experimental sample containing at least one glycan into two or more pools;
(b) selecting one pool prepared in (a);
(c) performing sequential mass spectrometry on the pool of (b);
(d) selecting a different pool prepared in (a);
(e) incubating the pool of (d) with a composition containing at least one glycosidase to yield a digest;
(f) performing tandem or sequential mass spectrometry on the digest of (e); and
(g) comparing the data obtained in (c) and (f);

where steps (d)-(g) are repeated for each remaining pool prepared in (a); and

where the digest of (e) is optionally purified prior to step (f).

In another aspect, the invention provides a method of detecting glycan isomers using sequential mass spectrometry (MSⁿ) including the steps of:
(a) proposing glycan structures for an experimental sample containing one or more glycans;
(b) comparing the proposed glycan structures of (a) with an MSⁿ spectrum obtained from the experimental sample;
(c) selecting a peak or peaks to be analyzed from the MSⁿ spectrum used in (b);
(d) identifying an extended m/z pathway for each peak identified in (c);
(e) converting each extended m/z pathway of (d) to a feasible composition pathway (FCP);
(f) predicting disassembly patterns of the proposed glycan structures in (a); and
(g) comparing the predicted disassembly patterns of (f) to the corresponding FCPs of (e); and
(h) using a scoring method to accept or reject each FCP that meets a threshold of acceptability, indicating that a glycan from (a) could or could not produce the observed FCP when sequentially disassembled; and

where the disassembly patterns are mapped to a precomputed composition database.

In certain embodiments, the peak selection of (c) is done by a human operator or using a computer algorithm or computer program.

In other embodiments, the scoring method includes identifying each FCP as consistent, possibly consistent, or inconsistent with the corresponding m/z pathway. In still other embodiments, the scoring method involves assigning numerical values to each FCP.

In another aspect, the invention provides a method of interactively annotating a MSⁿ spectrum of an experimental sample including the following steps:
(a) identifying possible compositions corresponding to the precursor ion of a spectrum
(b) comparing a given precursor/product composition pair using the residue counts, residue types, cleavage counts, or cleavage types, or any combination thereof;
(c) based on the comparison of (b), identifying compositions as possibly corresponding to the precursor or not corresponding to the precursor;
(d) optionally eliminating any compositions identified as not corresponding to the precursor in (c);
(e) for each composition eliminated in (c), propagating said elimination to direct or indirect product spectra;

where possible compositions that correspond to a precursor are used to annotate a spectrum;

where ions that do not satisfy a determined threshold are optionally excluded;

where any of the steps (a)-(e), or any combination thereof, may be performed on a precursor more than once; and

where steps (a)-(e) are optionally performed on more than one precursor in a spectrum.

In certain embodiments, the compositions identified in step (d) as not corresponding to the precursor in (c) are eliminated.

In other embodiments, the ions that do not satisfy a determined threshold are excluded. In still other embodiments, the determined threshold may be set by a human operator. In some embodiments, the determined threshold is set by a computer algorithm or program.

In some embodiments, the experimental sample includes a glycan. In certain embodiments, the glycan comprises a five-residue N-linked core.

In any of the methods of the invention, the glycan is a purified glycan, a native glycan, a derivatized glycan, or a glycan that has been cleaved from a glycoconjugate. In any of the methods of the invention, the glycan may be a synthetic glycan. In some embodiments, the glycan has been cleaved from a glycoconjugate using a chemical method or a physical method. In other embodiments, the glycan that is cleaved from a glycoconjugate is a native glycan.

In certain embodiments, the derivatized glycan results from chemical reduction, attachment of a mass tag to the reducing end, by functionalization of hydroxyl groups, or any combination thereof. In some embodiments, the derivatized glycan can be optionally purified.

Any of the methods of the invention may be used in any applications where structural analysis of glycans is useful. For example, the methods are useful for the analysis of biomolecules that have a glycoconjugate, including but not limited to, glycoproteins, glycolipids, and glycosaminoglycans (GAGs). These methods may also be used to analyze N-glycans, O-glycans, glycosaminoglycans (GAGs), and all other oligosaccharides that are not conjugated to another biomolecule.

Applications in which methods for the structural analysis of glycans are useful include, but are not limited to: biomarker discovery; drug discovery, manufacturing, and quality control; parasite/host interaction; infectious disease; egg fertilization; embryonic development; protein folding; glycan-modified protein function; cell adhesion; inter- and intra-cellular signaling; molecular recognition; allergic and inflammatory responses; and defective glycan metabolism (e.g., Congenital Disorders of Glycosylation, Gaucher, Fabry, Tay-Sachs, and Sandhoff diseases, among others). In all of these instances, the use of the methods of the invention can provide information about glycan structure that can lead to insights into biological function.

### DEFINITIONS

As used herein, by “candidate structure” is meant a proposed glycan structure or substructure resulting from analysis of fragmentation patterns. A candidate structure can be further analyzed to determine whether it has met a threshold level of acceptability established using scoring methods.

As used herein, by “corresponds sufficiently” is meant that the threshold level of acceptability established by the scoring method used for evaluation been met.

As used herein, by “derivatized glycan” is meant any glycan that has been chemically modified. Glycans can be chemically modified by procedures standard in the art that include, but are not limited to: chemical reduction, attachment of a mass tag to the reducing end, functionalization of hydroxyl groups (e.g., permethylation or peracetylation), or by any combination of these procedures. A derivatized glycan may be optionally purified. Derivatized glycans may optionally be released from a glycoconjugate by procedures standard in the art that include, but are not limited to: chemical methods (e.g., hydrazine or PNGase F) and physical methods (e.g., fragmentation via CID within a mass spectrometer).

As used herein, by “disassembly pattern” is meant any information about a set of glycan structures or substructures that results from performing a stepwise disassembly process on a sample, e.g., a polypeptide or fragment thereof, that includes a glycan. A non-limiting example of a disassembly pattern is the fragmentation pattern obtained by performing mass spectrometry on a sample.

As used herein, by “dissociation mode” is meant the method by which gas phase ions are fragmented in a stepwise disassembly pattern (for example, sequential mass spectrometry). In sequential mass spectrometry, exemplary dissociation modes include, but are not limited to: collision-induced dissociation (CID), in-source fragmentation, infrared multi-photon dissociation (IRMPD), electron capture dissociation (ECD), and electron transfer dissociation (ETD).

As used herein, by “downtree” or “down-tree” is meant the process of comparing a proposed glycan structure against successive product spectra, moving “down” the fragmentation tree. Scoring may be utilized to rank the proposed structures according to how well each fits the experimental spectra.

As used herein, by “experimental mode” is meant the type of charged gas phase ions produced by a mass spectrometry technique such as, for example, sequential mass spectrometry. In positive experimental mode, positively charged ions are produced. In negative experimental mode, negatively charged ions are produced.

As used herein, by “extended m/z pathway” is meant appending the m/z value of a peak observed in a mass spectrum to the m/z pathway associated with said mass spectrum.

As used herein, by “feasible composition pathway” or “FCP” is meant the compositions of a proposed glycan, or substructures thereof that could result from a stepwise disassembly process. Feasible composition pathways are generated from a corresponding extended m/z pathway.

As used herein, by “fragmentation” is meant the rupturing of covalent bonds in a glycan, or substructure thereof, following the performance of a stepwise disassembly process. For example, fragmentation can be accomplished by performing mass spectrometry on said glycan or substructure thereof.

As used herein, by “fragmentation pattern” is meant the collection of substructures formed by the fragmentation of a given glycan or a given substructure thereof. A fragmentation pattern is also a collection of fragmentation values. For example, performing mass spectrometry on a glycan will yield a collection of substructures that can be represented by the corresponding m/z peaks, often represented as a mass spectrum. In tandem mass spectrometry, the m/z peak representing an unfragmented glycan may be subsequently isolated and fragmented, yielding a fragmentation pattern for the m/z peak. In sequential mass spectrometry, also known as MSⁿ, this isolate/fragment cycle can be repeated multiple times, allowing for sequential disassembly of the glycan.

As used herein, by “fragmentation tree” is meant a collection of fragmentation patterns. The fragmentation tree includes the fragmentation pattern of the glycan as well as fragment patterns for the substructures formed from the initial fragmentation or from multiple disassembly steps. For example, sequential mass spectrometry on a glycan affords a fragmentation pattern that includes the peaks corresponding to the gas phase ions formed by the glycan as well as the peaks formed by further fragmentation of the gas phase ions.

As used herein, by “fragmentation value” is meant a numerical value used to represent the substructures formed following fragmentation of a glycan or substructures thereof. For example, the m/z value for a given peak represents the fragmentation value when mass spectrometry is used.

As used herein, by “glycan” is meant a monosaccharide, an oligosaccharide, a polysaccharide, or these structures found in glycoconjugates. Exemplary glycoconjugates are glycoproteins, glycolipids, and glycosaminoglycans. Glycoconjugates also include gangliosides. A glycan may be a native glycan or it may be a derivatized glycan. A glycan may be synthetic or naturally occurring. For example, a glycan may be a synthetic glycan having the structure of a native glycan. Both N-glycans and O-glycans are useful in the methods of the invention. Glycans that are purified are also useful in the methods of the invention. Glycans may optionally be released from a glycoconjugate by procedures standard in the art that include, but are not limited to: chemical methods (e.g., hydrazine or PNGase F) and physical methods (e.g., fragmentation via CID within a mass spectrometer).

As used herein, by “high abundance” is meant that the ratio of (peak intensity)/(intensity of most abundant ion in MS spectrum) for a given peak is determined to exceed a defined value. The ratio may be between the relative intensities of the target and most abundant peaks, the areas under the two peaks, or between any similar metric that expresses the relative abundance of the two peaks. The defined value may be established by the operator or through the use analytical software or other algorithms, or by a combination of operator and algorithms or software. For example, an operator or algorithm can determine that a high abundance peak occurs when the ratio of area of the selected peak to the most abundant peak is at least 0.05 (i.e., 5%).

As used herein in connection with the molecular structure of a glycan, by “internal” is meant a monosaccharide that not at the reducing end or at the non-reducing end of a glycan.

As used herein in connection with a fragmentation tree, by “intermediate member” is meant a member of the fragmentation tree that is not a terminal member or the root.

As used herein, by “ionization method” is meant a method by which a charge is imparted to a target molecule. Examples include electron ionization (EI), electrospray ionization (ESI), matrix-assisted laser desorption/ionization (MALDI), and surface-enhanced laser desorption/ionization (SELDI)

As used herein, by “mass tag” is meant an exogenous molecule that is covalently bound to the glycan, or substructure thereof, that facilitates structural analysis by mass spectrometry. Exemplary mass tags include, but are not limited to, 2-aminobenzoic acid (2-AA) and 2-aminobenzamide (2-AB).

As used herein, by “member of the fragmentation tree” is meant an entity that corresponds to the glycan or the substructures that form following a stepwise disassembly process. Members of the fragmentation tree include the root, the terminal members, and intermediate precursors. A non-limiting example is an intermediate mass spectrum obtained by sequential mass spectrometry.

As used herein, “m/z pathway” corresponds to a series of m/z values that represent one specific sequential disassembly of a glycan structure or substructure. Many different m/z pathways can be generated from the same glycan structure or substructure, each representing a different disassembly sequence.

As used herein, by “native glycan” is meant a glycan as it is found in nature. Native glycans may optionally be released from their glycoconjugate by procedures standard in the art that include, but are not limited to: chemical methods (e.g., hydrazine or PNGase F) and physical methods (e.g., fragmentation via CID within a mass spectrometer).

As used herein, “peak” refers to an observed m/z value in mass spectral data. A peak may be further analyzed to determine whether it is of sufficient abundance as to warrant analysis. This determination may be made manually by the operator or may be determined through the use analytical software or other algorithms, or by a combination of operator and algorithms or software. For example, an algorithm may facilitate the determination of peaks by excluding m/z values that correspond to isotopic variants of a given chemical structure. Peaks may also be referred to as “m/z peaks.”

As used herein, by “precomputed composition database” is meant a database that includes entries for both fragmented and unfragmented glycan compositions. The precomputed composition database may also include entries for glycans that include modifiers such as sulfate and phosphate groups.

As used herein, by “precursor fragmentation pattern” is meant the fragmentation pattern from which a product fragmentation pattern is generated. For example, in sequential mass spectrometry, an ion is isolated on a precursor spectrum and fragmented to produce a product spectrum.

As used herein, by “precursor ion” is meant an ion selected for fragmentation. For example, in sequential mass spectrometry, typically all ions within a given m/z isolation window are isolated and fragmented.

As used herein, by “product fragmentation pattern” is meant the fragmentation pattern resulting from the disassembly of a glycan structure or substructure. For example, in sequential mass spectrometry, isolating and fragmenting a particular m/z ion will generate a product spectrum.

As used herein, by “product ions” is meant ions created by fragmenting a precursor ion.

As used herein in connection with glycans, by “purification” is meant the process of preparing an experimental sample that includes a glycan such that impurities that include, for example, salts and detergents, have been removed. Purification can also refer to the fractionation of an experimental sample that includes more than one glycan by methods known in the art, e.g., high performance liquid chromatography (HPLC) or electrophoresis.

As used herein in connection with a fragmentation tree, by “root” is meant the member of a fragmentation tree that corresponds to the molecular weight of the original glycan structure or substructure submitted for analysis. Typically the root represents an unfragmented glycan, but can represent a glycoconjugate that has been fragmented from, e.g., a glycopeptide or ganglioside. For example, the root terminus of a fragmentation tree obtained using sequential mass spectrometry usually corresponds to the mass spectrum obtained by fragmenting the glycan once.

As used herein in connection with the molecular structure of a glycan, by “root” is meant a monosaccharide at the reducing end of a glycan.

As used herein, by “scoring method” is meant a method used to compare the predicted fragmentation of a glycan, or substructure thereof, with an experimental fragmentation pattern and to assign a value to the glycan, or substructure thereof, based on the comparison. The assigned value is then used to determine whether the proposed glycan, or substructure thereof, meets the threshold of acceptability. Scoring methods may include, but are not limited to, the following criteria: weighting the bond strengths of bonds ruptured in ionization; weighting the likelihood of formation of a proposed substructure; favorably weighting high abundance matching peaks in the experimental data and the predicted data for the candidate structure; penalizing a candidate structure if a predicted substructure has no corresponding experimental peak; or penalizing a candidate structure if a predicted substructure appears in the experimental data with significantly lower abundance than predicted.

As used herein, by “stepwise disassembly process” is meant any process that disassembles glycans in a stepwise fashion. An exemplary, desirable, stepwise disassembly process is sequential mass spectrometry. Stepwise disassembly of glycans may also be accomplished using chemical or biological agents, e.g., glycosidases. Alternatively, a stepwise disassembly process may use both sequential mass spectrometry and glycosidases.

As used herein, by “structure” is meant an unfragmented glycan or a glycan in which a cleavage event was applied to fragment the glycan from its glycoconjugate (for example, fragmenting the glycan off of a glycopeptide or a glycolipid).

As used herein, by “substructure” is meant a molecular fragment that results from performing a stepwise disassembly process on a glycan.

As used herein in connection with a fragmentation tree, by “terminal member” is meant the member of the fragmentation tree for which no further product spectra were generated. For example, in a fragmentation tree obtained using sequential mass spectrometry, generated terminal member is a spectrum for which no contained ion was selected for further fragmentation.

As used herein in connection with the molecular structure of a glycan, by “terminal” is meant a monosaccharide that is at the end of the glycan that is not the reducing end. A terminal monosaccharide may also be referred to as a “leaf.”

As used herein, by “terminus” is meant the member of the fragmentation tree that serves as the starting point for glycan sequencing. A terminus may be selected from a terminal member, the root, or an intermediate member.

As used herein, by “threshold level of acceptability” is meant a value used to determine whether a proposed glycan, or substructure thereof, is consistent with the experimental data.

As used herein, by “unfragmented” is meant a molecule that has not been subjected to a stepwise disassembly process. Such a molecule may also be referred to as a “parent” molecule. For example, “unfragmented glycan” can be used interchangeably with “parent glycan.”

As used herein, by “uptree” or “up-tree” is meant the process of creating proposed glycan structures and comparing them against successive precursor spectra, moving “up” the fragmentation tree. Scoring may be utilized to rank the proposed structures according to how well each fits the experimental spectra, and glycans that meet a threshold of acceptability may be passed to the precursor spectrum for further processing.

Other features and advantages of the invention will be apparent from the following Detailed Description, the drawings, and the claims.

### BRIEF DESCRIPTION OF THE DRAWINGS

FIG. 1 is a graph and a chart showing mass spectrometric data generated from the disassembly of a mixture of the GM1a/GM1b glycans and corresponding to m/z 1273.4.

FIG. 2 is a graph showing mass spectrometric data obtained from the disassembly of Fetuin and corresponding to m/z 1820.9²⁺.

FIG. 3 is a flowchart showing the gtSequenceGrow processing order for the MSⁿ tree. Processing steps are shown as circled numbers.

FIG. 4 is a MSⁿ tree showing two m/z pathways used to demonstrate the gtIsoDetect method. Putative compositions are shown at each step.

FIG. 5 is an outline of the gtIsoDetect method.

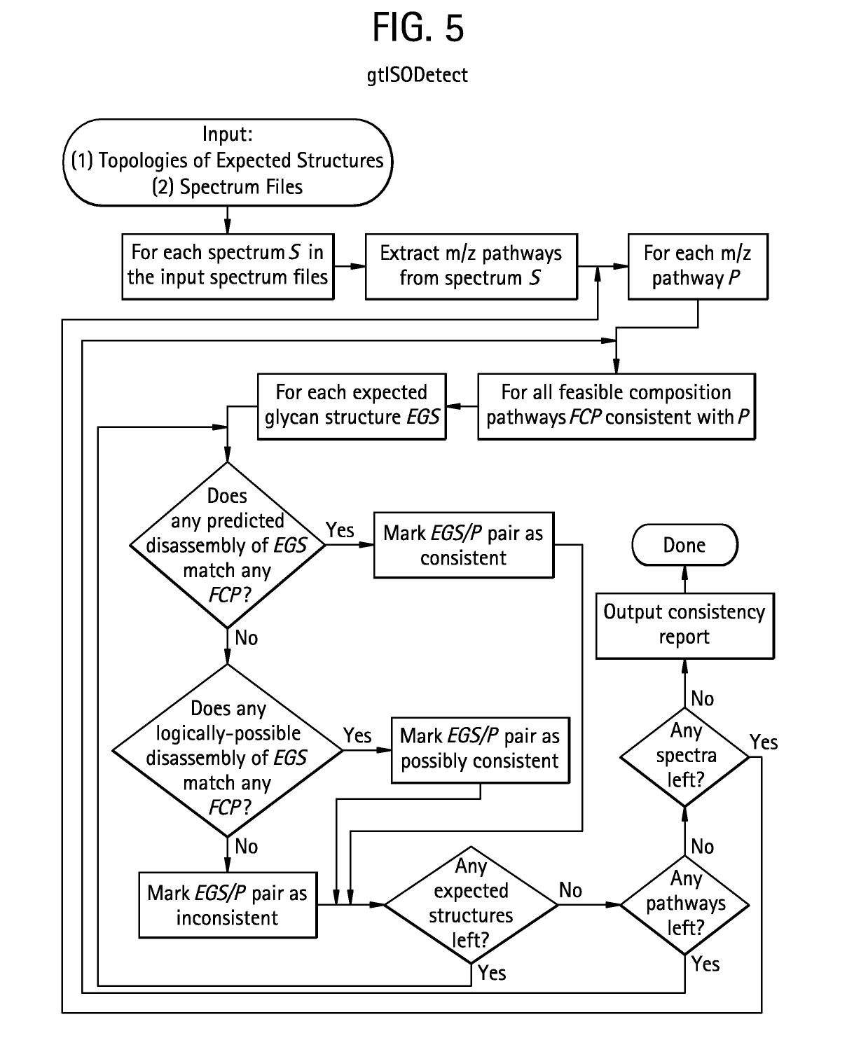

FIG. 6 is an illustration showing a computerized user interface used for the interactive annotation of spectra.

FIG. 7 is an illustration showing a computerized user interface used for the gtIsoDetect algorithm. It shows the analysis of multiple disassembly pathways (box labeled “Compatibility Report”) against two candidate structures (box labeled “Enter Expected Structures”). The selected disassembly pathway is elaborated upon in the right two boxes, “Structure” and “Pathway Details,” with the former highlighting nodes 5 and 6, which are compatible with ion m/z 444.00 in the pathway.

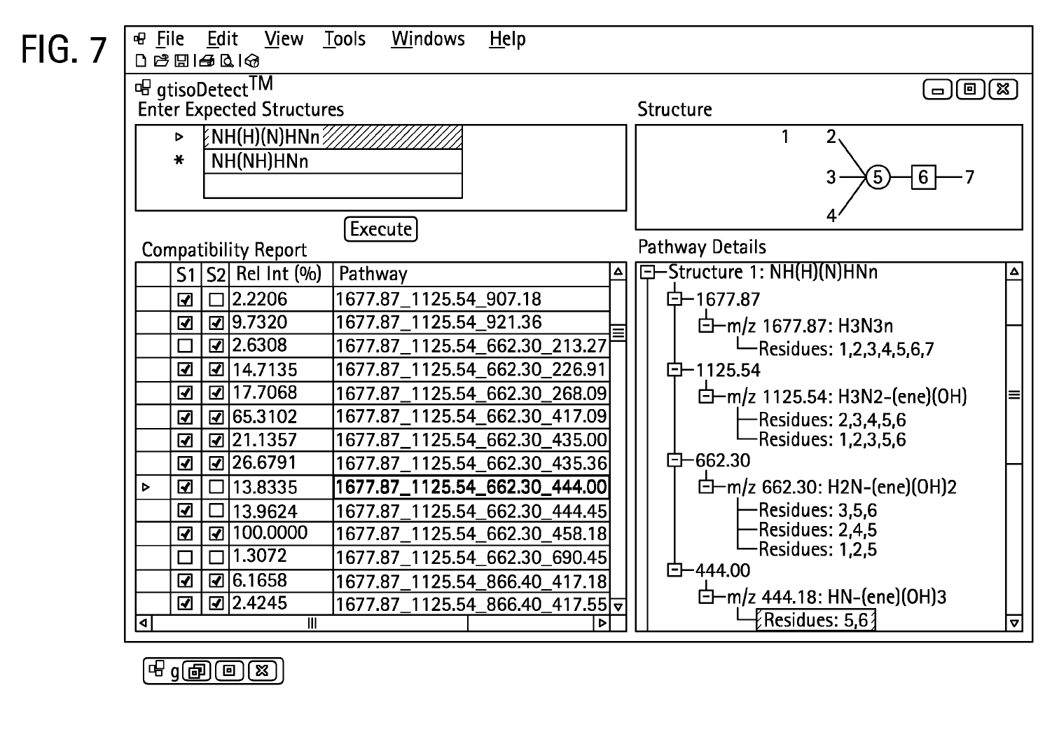

### DETAILED DESCRIPTION

The invention provides methods useful for glycan structural analysis that employ stepwise disassembly processes. Analysis of the fragments generated by such processes is used, for example, in glycan sequencing and in determining the presence of isomeric glycans. Stepwise disassembly processes include mass spectrometry (MS) and sequential mass spectrometry (MSⁿ). The invention also provides methods of interactive spectra annotation.

### Glycan Notation

Glycans are formed from monosaccharide building blocks including, for example, glucose (Glc), mannose (Man), galactose (Gal), fucose (Fuc), β-D-N-acetylglucosamine (GlcNAc), N-acetylgalactosamine (GalNAc), and N-acetylneuraminic acid (Neu5Ac). The monosaccharides that form the glycan are also known as residues. Other monosaccharides of interest include, but are not limited to, xylose, iduronic acid, frutose, glucuronic acid, and ribose.

Scheme 1 shows the results of derivatization on the monosaccharides introduced above. We establish class names to represent monomers with identical masses: H for hexose (glucose, mannose, and galactose); F for deoxyhexose (fucose); N for HexNAc (GlcNAc and GalNAc); and S for the sialic acid NeuAc. The methods of the invention support residues that include the three reduced residues derived from H, F, and N; these are designated h, f, and n, respectively. The methods of the invention will also support other residues such as, for example, xylose, the sialic acid NeuGc, and so on, as well as their reduced counterparts.

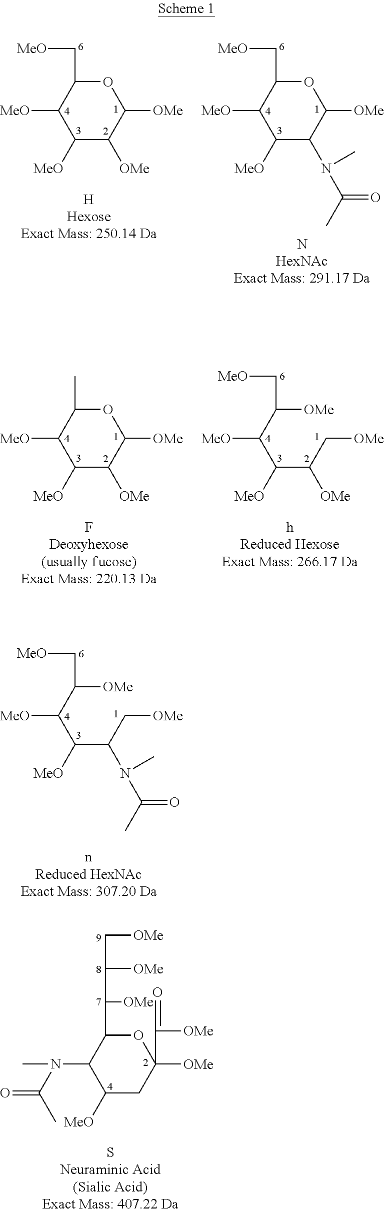

Scheme 2 shows a simplified representation of the monosaccharides from Scheme 1. A reduced residue is distinguished by the case of its label, not by a difference in shape. This representation is a simplification of the standards established by the Nomenclature Committee of the Consortium for Functional Glycomics.

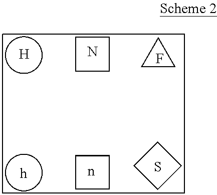

Interresidue Linkage and Anomericity

Monosaccharides combine to form disaccharides, trisaccharides, and so on, by forming glycosidic bonds in one of two possible stereochemical anomeric orientations, axial (alpha or a) or equatorial (beta or (3). The interresidue bonds extend from the anomeric carbon (carbon 2 for sialic acid, carbon 1 otherwise) of the non-reducing-end sugar to an available position (carbons 4, 7, 8 or 9 for sialic acid; otherwise a subset of carbons 2, 3, 4, or 6) of the reducing-end sugar. The linkage positions for certain residues are shown in Scheme 1, with the anomeric carbons highlighted. Other monosaccharide residues, for example fructose, have different linkage positions.

Scheme 3 shows a hypothetical trisaccharide with individual residues labeled with superscripts. Residue F⁰ is terminal (a leaf), H¹ in internal, and n² is at the reducing end (the root). Using the linkage positions shown, we would designate this structure as F1-4H1-4n; that is, an F residue 1-4 linked to an H, which is 1-4 linked to n.

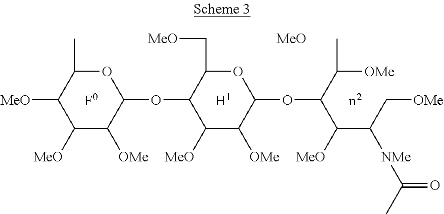

Domon/Costello Fragment Nomenclature

A popular fragment nomenclature was established in Domon and Costello, Glycoconjugate J., 5: 397-409 (1988). Among other things, it defines particular ion fragments as being of type A, B, C, X, Y, or Z. Ion types B/Y and C/Z are complementary fragments caused by cleavages around the glycosidic oxygen. Scheme 4 is used to illustrate the nomenclature as used herein.

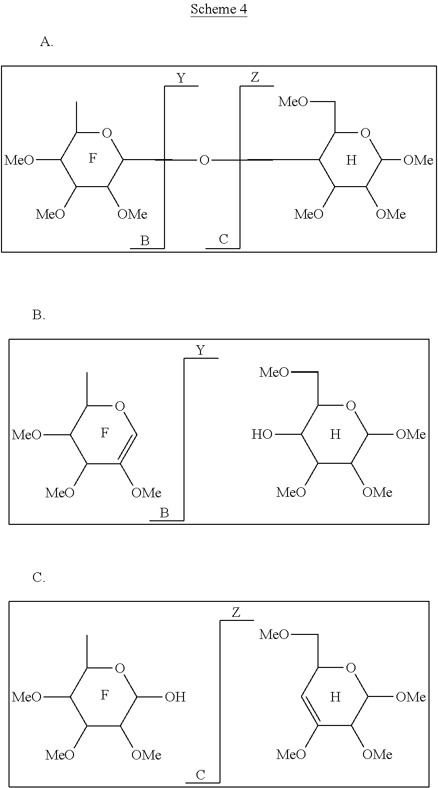

Scheme 4A shows a fully methylated FH disaccharide. According to the customary usage, the rightmost residue is the reducing end. There are two pairs of fragments that can be formed by cleavages around the glycosidic oxygen. Scheme 4B shows a cleavage to the non-reducing side of the oxygen, yielding F-(ene) and H-(oh) fragments; these are, respectively, B and Y ions. Scheme 4C shows a cleavage to the reducing side of the oxygen, yielding F-(oh) and H-(ene) fragments, also called C and Z, respectively.

Generally speaking, a B-type ion indicates an (ene) cleavage at the fragment's reducing end, C-type indicates an (oh) at the reducing end, Y-type indicated an (oh) at the non-reducing end, and Z-type indicates an (ene) at the non-reducing end. Both B/Y and C/Z are complementary pairs.

As an extension of this nomenclature, used herein is notation such as B/Y/Y, meaning a fragment with one (ene) cleavage at the reducing end and two (oh) cleavages at the non-reducing end.

The terms (ene) and (oh) do not imply the location of the scars; the B/C/Y/Z notation is required for that. As such, the (ene)/(oh) notation is better suited to compositions and the B/C/Y/Z notation is better suited for fragments.

Domon and Costello also define A- and X-type ions, which represent cleavages across the sugar ring (i.e., cross-ring fragments). Scheme 6 shows one cross-ring fragment that might be observed: part of the H's ring is still attached to the terminal F. The mass of this cross-ring fragment reveals that F⁰ is linked to either position 4 or 6 of H¹. The linkage could just have easily been 1-6 instead of the shown 1-4; the mass of the fragment would have been identical. Multiple cross-ring cleavages are sometimes required to confirm a linkage assignment.

Cross-ring fragments are identified by the bonds cleaved to generate the fragment and whether or not the fragment contains the anomeric carbon of the cleaved residue. Scheme 5 shows the bond numbering for a hexose residue. All residues supported by the methods of the invention described herein share this scheme. In this scheme, bond numbers match the carbon which they follow.

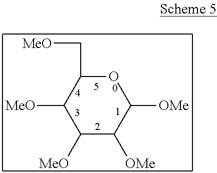

Scheme 6 shows the two fragments that would result from cleaving bonds three and five of the reducing-end hexose. The fragment without the anomeric carbon (labeled “1”) is denoted the ^{3,5}A fragment; the complementary fragment is denoted ^{3,5}X. The cross-ring fragment of 6 could more precisely be described as having composition F-^{3,5}A[HNn], where the [HNn] denotes the residue classes that might have generated the cross-ring fragment. H, N, and n all share the same atomic structure at the relevant parts of the residues, and hence any of these might have generated the fragment. F-^{3,5}A[F] is not a valid composition, as a reducing-end F residue could not produce the fragment exactly as shown—F has no OMe at carbon six. In this case, we know the cross-ring fragment came from a hexose (residue H¹, to be specific) and so we further simplify the notation of this fragment from F-^{3,5}A[HNn] to F-^{3,5}A[H].

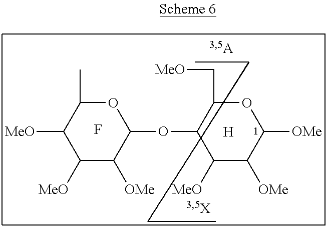

Composition Notation

Residue compositions are given as residue counts paired with scars. For example, H₄N₂n represents a composition of four hexoses, two HexNAcs, and one reduced HexNAc. Scars are denoted by (oh) and (ene) modifiers, each of which may be modified by a count. A few examples:
H-(oh) represents a single hexose with one (oh) scar. The composition does not specify whether the scar is on the reducing end or the non-reducing end of the hexose.
HN-(oh)₂ represents a Hex-HexNAc dimer, which jointly contains two (oh) scars. The composition does not specify which residues contain which scars.
H₃-(ene)(oh)₂ represents a hexose trimer with both one (ene) and two (oh) scars.

Subscripts denote the number of monomers in an ion composition (e.g., H₂ means two hexoses) and superscripts identify particular residues (H² means the hexose with index 2).

Annotated Disassembly Pathways

In the methods of the invention, some commands accept an m/z disassembly pathway as an argument. For example, the input notation 1636.8_{—}914.4_{—}710.3_{—}506.2_{—}316.2 represents the pathway m/z 1636.8→914.4→710.3→506.2→316.2.

Each ion in the pathway may optionally be annotated with additional bracketed information. A charge state is given as n+ or n−. If no charge state is given, 1+ is assumed. For example,

1141.6[2+]_{—}1012.0[2+]_{—}1537.0 represents a pathway with the first two ions assigned a charge state of 2+ and the last ion assigned, by default, a charge state of 1+.

Ions in the pathway can also be annotated with an “XR” to indicate that cross-ring fragment compositions can be considered for that ion. In the absence of the XR suffix, ions are interpreted as having compositions consistent with the result of multiple glycosidic cleavages only. For example, in this pathway 1636.8_{—}914.4_{—}710.3_{—}506.2_{—}316.2 [XR], only the last ion (m/z 316.2) will entertain cross-ring fragments for its composition; all other ions in the pathway will consider only glycosidic fragments.

Ion annotations can be combined in a comma-separated list. For example, 1141.6[2+, XR] is a doubly-charged ion that allows cross-ring cleavage interpretations.

Structure Notation (Linear Code)

It is often convenient to represent a glycan structure using text instead of a diagram. The representation used by the methods of the invention is based upon the standards established by the Nomenclature Committee of the Consortium for Functional Genomics. In this linear code, reading from left-to-right moves from the non-reducing-end of the glycan to the reducing end, and so the final monomer listed is the reducing-end residue. Parentheses designate branching.

Table 1 shows a series of hypothetical glycan topologies along with the linear code for each. As residues are added, the topology's complexity increases. In this example, n is always the reducing end residue (or, correspondingly, the root of the tree). Topology 1 shows that linear glycans require no parentheses in their linear code, because, of course, they are not branched. Topology 2 show how a simple branch is represented in the linear code: One of the branches is parenthesized, but the other is not. (In our notation, the choice of which branch to parenthesize is arbitrary; other similar notations specify complex rules to generate canonical representations.) Topology 3 shows that branches can themselves contain linear components, and so FH and (SH) represent the two non-reducing-end linear sequences. Topology 4 shows how additional branching is represented. Here the right-most H residue has three branches, represented as FH, (SH), and (N) in the linear code. Similarly, we see a reducing-end fucose-substituted n, represented (F)n.

The simple five residue N-linked core (topology 2 in Table 1) is represented H (H) HNn. Optional interresidue linkages may be given as well, yielding H6 (H3) H4N4n. An alternative form is available, where the anomeric carbon that originates the glycosidic bond is also listed: H1-6 (H1-3) H1-4N1-4n. Finally, alpha/beta anomericity may also be included: Ha1-6 (Ha1-3) Hb1-4Nb14n. For N-linked structures, the user must indicate each core residue by applying a prime: H′ (H′)H′ N′ n′. If the reducing end of the glycan contains a scar, -(oh) or -(ene) may be appended.

Note that linkage designators are neither subscripted nor superscripted, avoiding possible confusion with monomer quantities or indices, respectively.

The linear code used herein will omit optional components not relevant to the particular algorithm being discussed. For example, when anomericity is not being considered when using the methods of the invention, a/b will always be eliminated.

TABLE 1

| # | Hypothetical Topology | Linear Code |
|---|---|---|
| 1 | 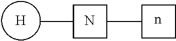 | HNn |
| 2 | 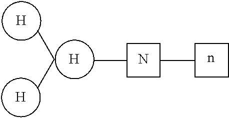 | H(H)HNn |
| 3 | 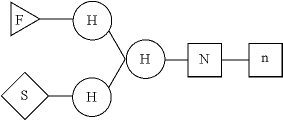 | FH(SH)HNn |
| 4 | 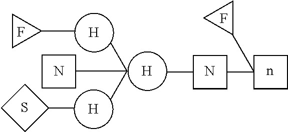 | FH(SH)(N)HN(F)n |

### Comparison of Terminology Used in Mass Spectrometry and Computer Science

Table 2 defines some equivalent terms which are used interchangeably herein.

TABLE 2

| Chemistry | Computer Science |
|---|---|
| Glycan | Tree |
| The glycan's residues are H⁰, H¹, H², N³, n⁴ | The tree's nodes are H⁰, H¹, H², N³, n⁴ |
| n⁴ is the reducing-end residue | n⁴ is the root of the tree |
| H¹ is a non-reducing-end terminal residue | H¹ is a leaf |
| H¹ forms a glycosidic bond with H² | H¹ is a child of H² (or H² is the parent of H¹) |
| H² has two substituents, H⁰ and H¹ | H² has two children, H⁰ and H¹ |

### Glycans

The methods of this invention are applicable to glycan types that include, but not limited to: monosaccharides; glycoconjugates (for example, glycoproteins, glycolipids, and glycosaminoglycans), oligosaccharides, and polysaccharides.

Derivatized glycans may be used in the methods of the invention. Analysts routinely derivatize (chemically modify) glycans before MSⁿ analysis.

Glycans can be first released from their conjoiners and purified. For example, a native glycan can be released from a glycoconjugate such as, for example, a glycoprotein, glycolipid, or glycosaminoglycan. Glycans that are released from their conjoiners can afford a complex mixture of oligosaccharides, and direct links back to their sources are lost. Frequently, the exposed hemiacetal bond is reduced to form an alditol, breaking the carbon ring of the reducing-end (root) sugar and giving it a modified mass that serves as a reference anchor during MSⁿ analysis. An exemplary reducing agent used in such processes in sodium borohydride. Other reducing-end tags such as 2-aminobenzoic acid (“2-AA”) and 2-aminobenzamide (“2AB”) can also be used to derivative glycans analyzed using the methods of the invention.

Glycans can also be permethylated. Here, methylation replaces all acidic protons, in effect converting all hydroxyl groups (OH) to methoxyl groups (OCH₃, abbreviated OMe). Permethylation allows for the detection of cleavages between residues, as will be discussed herein. The complex glycan mixture may optionally be separated, by LC (liquid chromatography) or similar techniques, to reduce the number of glycan structures examined at one time.

N-Glycans and O-Glycans

N-linked glycans, or simply N-glycans, are always attached to proteins at the nitrogen atom (hence, “N”) of the amide group of an asparagine amino acid residue. Importantly, they nearly always contain a trimannosyl core consisting of five residues linked in an unwavering formation: two mannoses α1-3 and α1-6 connected to a single mannose, which is β1-4 connected to an internal GlcNAc, which is β1-4 connected to the reducing end GlcNAc. See Scheme 7. Larger N-glycans attach additional residues to this core.

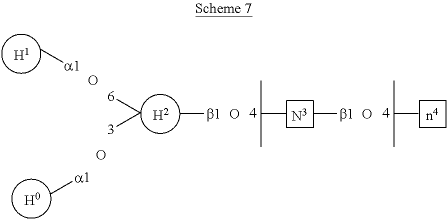

O-linked glycans, or O-glycans, are attached to the oxygen atom (hence, “O”) of a serine or threonine amino acid. They commonly consist of from one up to approximately a dozen residues and are often classified according to a series of common core structures, Core 1-Core 8, as shown on page 93 of Brooks et al. in Functional and Molecular Glycobiology, BIOS Scientific Publishers Limited (2002).

### Composition Database

The methods of the invention map masses to possible compositions via a precomputed database. It includes entries for both fragmented and unfragmented glycan compositions. The database contains compositions, not structures. The database contains entries for glycans composed of (a limited number of) residues and glycan modifiers such as sulfate and phosphate groups, plus fragment entries that allow for the presence of scars on each of these compositions. Given an observed mass, the database returns a list of glycan compositions and glycan fragment compositions that fall within the experimental error of the mass. The tools then use these compositions to complete their tasks. For example, an observed sodiated ion with m/z 1187.7 would be mapped to the glycan composition H₃Nn, plus any other compositions that fall within the specified error tolerance of 1187.7. The composition database utilized in the context of this invention is structurally similar to the one described in section 3.5 of Lapadula, Ph.D. Dissertation, University of New Hampshire, Durham, (2007), herein incorporated by reference, with extensions for phosphate and sulfate modifiers, additional cross-ring cleavages, and additional monomer types. Consequently, it is evident to one skilled in the art that the composition database can be assembled using comparable methods.

### Stepwise Disassembly Methods

The methods of the invention are applicable to any stepwise disassembly process performed on a glycan. Such methods include, but are not limited to, mass spectrometric techniques and chemical methods of disassembly (for example, the use of glycosidases). The methods of the invention are also useful with combinations of stepwise disassembly methods. For example, the methods of the invention include performing mass spectrometry on the products resulting from treatment of a glycan (or mixture of glycans) with glycosidases.

Glycosidases

A method well known in the field utilizes glycosidase digests to remove selected monosaccharide residues from glycans. By alternating the application of various glycosidases with measurement techniques such as tandem MS, the target glycan can be sequentially disassembled. The structural changes can be noted after each digest, and the original structure of the glycan can be determined.

Exemplary, non-limiting glycosidases useful in the invention include endoglycosidases and exoglycosidases. Other exemplary glycosidases include amylases, chitinases, fucosidases, galactosidases, hyaluronidases, invertases, lactases, maltases, mannosidases, N-Acetylgalactosaminidases, N-Acetylglucosaminidases, N-Acetylhexosaminidases, neuraminidases, sucrases, and lysozymes. Still other examples of glycosidases include beta-glucosidase; beta-galactosidase; 6-phospho-beta-galactosidase; 6-phospho-beta-glucosidase; lactase-phlorizin hydrolase;; beta-mannosidase; myrosinase; PNGase F; Peptide-N-Glycosidase A; O-Glycosidase; Endoglycosidase F₁; Endoglycosidase F₂; Endoglycosidase F₃; Endoglycosidase H; Endo-β-galactosidase; Glycopeptidase A; Lacto-N-biosidase.

Mass Spectrometry (MS)

A number of ionization and detection technologies are available for use in Mass spectrometry. Regardless of ionization source (e.g., electrospray (ESI), Matrix Assisted Laser Desorption Ionization (MALDI)), sequential mass spectrometry (MSⁿ), often implemented using an ion trap (IT-MS), allows the operator to select peaks (“precursor ions”) from a spectrum, fragment them, and record the resulting “product ions” in another spectrum. In sequential mass spectrometry, peak fragmentation is iterative and may be performed as many times as required. In some instances, fragmentation may be limited by the physical capabilities of the instruments. Fragmenting a peak from the initial MS spectrum yields an MS² spectrum; fragmenting a peak from that yields an MS³ spectrum, and so on.

The fragments generated by MSⁿ disassembly can be analyzed by an analyst and are used in the methods of the invention. For example, glycosidic bonds joining monomers are often the most labile and where fragmentation often occurs. Thus, it is frequently the case that the most abundant ions are the result of glycosidic cleavages. Cross-ring cleavages, multiple simultaneous cleavages, and other interpretations are possible as well, but these typically yield lower-intensity peaks when using permethylated glycans.

Derivatization of a glycan can also influence the type of fragments formed (e.g., with the lower-intensity peaks discussed above). Additionally, for permethylated glycans, the fragments generated during MSⁿ preserve hints of their original connectivity. Exemplary types of fragments that can form are those that include 1,2-double bonds (“ene”) or those that include a terminal hydroxyl (“oh”). Specifically, the number of (ene) and (oh) scars in each composition indicate the number of cleavages applied to the fragment, although the original linkage and identity of the cleaved residues are not directly recorded. In this case, the observed composition n-(oh) reveals only that the n residue had a single residue connected directly to it, but not the identity of the residue. Similarly, the H-(ene)(oh) fragment tells us that the H residue had previously been directly connected to two residues, and F-(ene) indicates that the F residue had only a single attached residue.

### Scoring Methods

The invention includes the use of scoring methods in order to compare the predicted fragmentation of a glycan, or substructure thereof, with an experimental fragmentation pattern and to assign a value to the glycan, or substructure thereof, based on the comparison. The assigned value is then used to determine whether the proposed glycan, or substructure thereof, meets the threshold of acceptability.

Scoring methods may include, but are not limited to, the following criteria:
weighting the bond strengths of bonds ruptured in ionization;
weighting the likelihood of formation of a proposed substructure;
favorably weighting high abundance matching peaks in the experimental data and the predicted data for the candidate structure;
penalizing a candidate structure if a predicted substructure has no corresponding experimental peak; or
penalizing a candidate structure if a predicted substructure appears in the experimental data with significantly lower abundance than predicted.

Scoring methods used in the invention can use descriptive terms as assigned values (for example, “consistent,” “possibly consistent,” or “inconsistent”). Alternatively, numerical values may be used as the assigned value.

Methods for Detection of Glycan Isomers (“gtIsoDetect”)

One method of the invention can be used to detect disassembly pathways that likely did not come from a set of expected glycan structures. These detected pathways may instead have originated from structural isomers. Often an analyst will assume that particular glycan structures are present, and wish to be told which pathways appear to indicate the presence of isomers. Put another way, the analyst would like a list of pathways that do not appear to have come from the expected structures. These issues are addressed by the method of the invention for detecting glycan isomers.

Using the glycan isomer detection method of the invention, it can be determined if a given structure can be sequentially disassembled in such a way as to match the observed ions generated by an MSⁿ experiment. The method enables the comparison of each structure against each MSⁿ pathway (as extracted from the MSⁿ spectra) and produces a full report on the consistency of every structure/pathway pair.

Broadly speaking, the method for detection of glycan isomers includes the following features:
1) It converts a peak's m/z pathway into a set of feasible composition pathways.
2) It attempts to find a sequential disassembly of an expected glycan structure such that the disassembly yields a sequence of compositions that match one of the feasible composition pathways for the m/z pathway.
3) The m/z pathway and structure will be labeled as being consistent, possibly consistent, or inconsistent with each other, as follows:
   a. If some predicted disassembly of the structure matches the pathway, they are consistent.
   b. If some unpredicted but logically possible disassembly of the structure matches the pathway, they are possibly consistent.
   c. Otherwise, they are inconsistent.

A pathway that is possibly consistent or not consistent may actually represent the disassembly of an unexpected glycan structure which may merit further attention from the analyst.

Step (3) mentions the “predicted disassembly” of a glycan. A detailed example of this for permethylated glycans in positive mode is described in Example 1 and Example 2.

The method for detection of glycan isomers can be performed in the following manner:
1) Accept as input (A) a set of expected glycan structures and (B) a set of spectra to process
2) For each input spectrum S:
   a. Spectrum S will have an m/z pathway associated with it, detailing the ions selected and fragmented to generate the spectrum. For each peak on spectrum S, create an extended m/z pathway P that appends the peak to the pathway for S. (E.g., a peak with m/z 486.2 on spectrum 1273.5_{—}898.3 would be represented by the extended pathway 1273.5_{—}898.3_{—}486.2). Peaks can be extracted from spectra by various methods known to those skilled in the art. For example, an algorithm that uses a simple “local maximum” strategy can be used. Alternatively, an algorithm that understands isotopic envelopes can be employed in order to avoid processing the non-monoisotopic peaks in envelopes.
   b. Convert the extended m/z pathway P to feasible composition pathways (FCPs). (E.g., the m/z pathway 1273.5→898.3→486.2 is converted into the feasible composition pathway H₃NS-(oh)→H₃N-(oh)₂→HN-(ene).)
      i. If more than one composition is possible for one or more of the pathway ions, all composition combinations must be processed. This means a single m/z pathway may generate multiple FCPs.
      ii. If some ion in the m/z pathway has no known composition, the m/z pathway can be reported as having an unknown composition and no further processing of it need be done.
   c. For each expected glycan structure, label the m/z pathway/structure pair as follows:
      i. If there is any predicted disassembly of the glycan structure that matches any FCP (that is, every composition in some FCP is matched by the predicted sequential disassembly of the glycan), label the m/z pathway/structure pair as consistent;
      ii. Otherwise if there is any logically-possible disassembly of the glycan structure that matches any FCP, label the m/z pathway/structure pair as possibly consistent;
      iii. Otherwise, the pathway/structure pair is labeled as inconsistent.
      iv. The process of determining if a glycan disassembly matches an FCP is equivalent to recursively disassembling the expected glycan. For the pathway 1273.5_{—}898.3_{—}486.2_{—}259.1, for example, all fragments with m/z 898.3 are searched for an embedded fragment with m/z 486.2, and each of those is searched for an embedded m/z 259.1.
   d. Output the m/z pathway/structure pair and its consistency label.

### Extensions

The method for detecting glycan isomers described above may also be modified according to the following ways.

Arbitrary Cleavages

The glycan isomer detection method described above works with more than just glycosidic cleavages. It also handles cross-ring cleavages as well as other “non-standard” losses that can nonetheless be predicted from an expected glycan structure. For example, permethylated HexNAc (N) residues often lose their acetyl and N-acetyl groups, which register as losses of 42 Da and 74 Da, respectively. These peaks can easily be understood by gtIsoDetect even though they are not the result of glycosidic cleavages.

Linkage Isomers

Because the method for detecting glycan isomers works with cross-ring cleavages, it can be used to find structural isomers that differ only in linkage. For example, the cross-ring fragments generated by a H1-6N disaccharide (that is, a hexose that is 1-6 linked to a HexNAc) differ from the cross-ring fragments from a H1-3N disaccharide. If the expected linkage was 1-6, but 1-3 fragments were observed in the spectrum, the 1-3 fragments would be called out as inconsistent with the expected structure. In this way, the operator can identify “linkage isomers” using the methods described herein.

Methods for Selecting Residues for Each Composition

The method of detecting glycan isomers can determine which residues in a proposed structure can map to the compositions in a feasible composition pathway. The only requirement of this process is that the residues in a given composition be connected together, and for permethylated glycans, be removable from the glycan by cleavages that leave the expected number and type of scars. An exhaustive search for these embedded compositions is a baseline strategy, but can clearly be improved upon using various techniques such as those described herein. One possible implementation may be performed according to the following procedure:
1. Assume a search for the embedded glycan substructures that match a given composition C.
2. For each residue R in the precursor structure:
   a. Assume R is the root of the embedded substructure.
   b. Perform an exhaustive recursive search of the glycan tree starting at R.
   c. Record/report all subtrees found that match composition C in both the residues and scars contained.

Various optimizations can be performed to increase the efficiency of the search for residues that match a given composition.

For example, as soon as a subtree contains too many residues of a particular type, that branch of the search can be abandoned. Or, if the subtree under R does not contain enough residues of the appropriate types to aggregate into the target composition, that search branch can be abandoned.

More generally speaking, each residue in the glycan can be marked with the sum of the residue types found in the subtree rooted at the residue. This allows the pruning of the search for subtrees, greatly increasing efficiency.

An expanded version of this optimization can also store, at each residue, (1) the minimum and maximum number of (ene) and (oh) cleavages predicted to occur in the residue's subtree, (2) the minimum and maximum number of possible (not predicted) cleavages that could occur in the residue's subtree. Here (1) allows efficient search pruning for the case where the target composition has a known scar count (as when dealing with permethylated glycans) and (2) allows efficient search pruning for the case where scar counts are not available (as when dealing with native glycans).

A given precursor structure may contain multiple internal substructures that match composition C. (For example, there may be multiple ways to extract HN-(ene) from a glycan.) The gtIsoDetect algorithm can find and report all of these substructures.

Native Glycans

This method for detecting glycan isomers can also be used with native glycans. In native glycans, there are fewer “scars” left behind when residues are cleaved, and so strict scar counts cannot be used in the feasible composition pathways. However, just using the residue counts in the composition is enough to make gtIsoDetect useful for native glycans. For example, if a native fragment was determined to contain three residues, H₂S, those three residues can be extracted from GM1a (residues H⁰H²S⁴) but not from GM1b (as GM1b does not embed a H₂S connected substructure). This is described further in Example 1, Scheme 8 of the specification. Therefore any native pathway containing H₂S is marked as inconsistent with GM1b, even though exact scar counts are not used.

Multiply-Charged Ions

In addition to singly-charged ions, the methods of the invention can also be used with multiply-charged ions. If ion charge states are determined independently (either by software or by an analyst), the algorithm executes in exactly the same way.

Ions with an undetermined charge state can be processed multiple times, once for each possible charge state. For example, if the doubly-charged precursor m/z 1890.2²⁺ yields the product ion m/z 678.4 with an unknown charge state (but which must necessarily be either 2+ or 1+), the method described above could examine this pathway as both 1890.2²⁺_{—}678.4²⁺ and 1809.2²⁺_{—}678.4¹⁺, reporting both results or reporting only the result that is most consistent with an expected structure.

### Methods for Glycan Sequencing

The invention provides methods to reconstruct a glycan's original topology given fragmentation data in the form of data obtained from sequential disassembly methods, e.g., MSⁿ spectra. The invention provides methods for glycan sequencing that employ processes that disassemble glycans in a step-wise fashion. Exemplary stepwise disassembly processes include, but are not limited to, mass spectrometry (e.g., sequential mass spectrometry) and the use of glycosidases to chemically disassemble glycans.

The methods of the invention include taking a precursor structure, for example, an intact glycan or a previously-disassembled fragment, and predicting which product fragments would arise if the substructure were fragmented again.

gtSequenceGrow

One method of the invention for glycan sequencing couples the product fragment prediction process described above with the precursor/product nature inherent in glycan disassembly to derive glycan structures. This method is herein referred to as “gtSequenceGrow.”

Other sequencing methods have had limited success because they attempt to enumerate all possible glycans of a given composition and then score each of those glycans against the experimental data. However, once glycans pass a modest size, the vast number of possible structures makes these methods intractable.

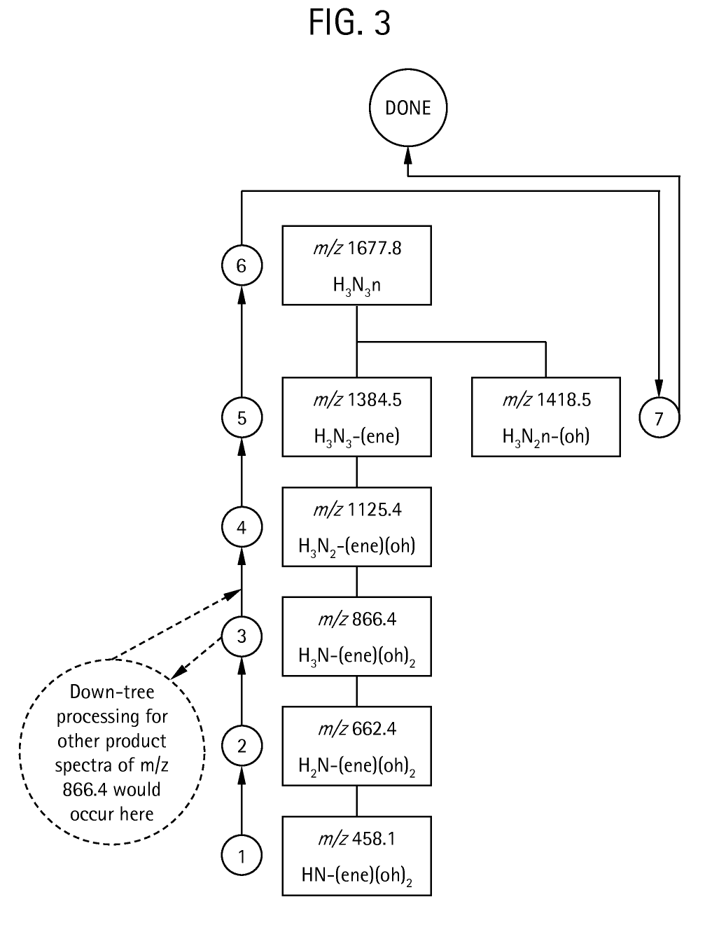

The gtSequenceGrow method solves this problem by interleaving up-tree and down-tree phases, walking up and down the MSⁿ spectrum tree. The method may be performed as illustrated in FIG. 3. The algorithm begins with an up-tree phase, starting at the bottom of the MSⁿ spectrum tree. It creates a set of possible candidate substructures (for example, a set of all possible candidate substructures can be created) for this spectrum's composition, scores each candidate according to how abundant its predicted fragment ions are in the spectrum, and passes the best candidates structures up to the precursor spectrum for continued processing. At this stage (Step 2), the best candidates are grown by the addition of residues and the modification of scars to match the target composition. All possible modifications of the candidates are created in Step 2, and they are again scored against the experimental spectrum, culled, and passed to the precursor spectrum for Step 3. This up-tree process continues until the highest scoring candidates reach the top of the tree (Step 6).

To better discriminate between candidates, and to make use of the full MSⁿ spectrum tree, gtSequenceGrow also implements a down-tree phase that interrupts the up-tree phase when suitable MSⁿ spectra are available. When multiple product spectra are available, and when those spectra are compatible with the candidates under consideration, the candidates are passed down the MSⁿ spectrum tree (Step 7). At each step, the candidate is predictively fragmented and compared against the experimental spectrum. The candidate's score is updated accordingly: product spectra that include the candidate's predicted fragments increase the candidate's score, and spectra that do not decrease its score.

Each candidate from Step 6 is passed recursively down the MSⁿ spectrum tree and all spectra that the candidate might have reasonably generated participate in updating the candidate's score. This down-tree processing is very similar to the disassembly process used by gtIsoDetect to identify isomeric fragment peaks. As described herein, the same problem must be faced in gtSequenceGrow of deciding whether a given structure should be considered compatible with a given spectrum—that is, given a candidate structure, determining whether a particular spectrum be used to modify the candidate's score. If the spectrum could not have been generated by the candidate, the candidate's score should not suffer. The candidate should not be penalized just because spectra were collected from an incompatible isomer. To solve this problem, we utilize the gtIsoDetect solution again. As used herein, consistent means that the fragment was predicted, possibly consistent means that the fragment was not predicted but is logically possible to predict, and inconsistent means that the fragment was not predicted or possible to predict.

Given product spectrum S and candidate C, the gtSequenceGrow method can include the following features:

1) Always apply S to C's score if C is consistent with S (that is, C is predicted to fragment in such a way as to generate S);

2) Optionally apply S to C's score if C is possibly consistent with S; and

3) Never apply S to C's score if C is inconsistent with S

The optional application of S to C in the possibly consistent case can be resolved by having the algorithm accept an appropriate decision input from the user. In certain implementations of this method, the analyst (or some external algorithm) is able to make this “do/do not apply” decision each time a possibly consistent spectrum is considered.

When all up-tree and down-tree processing has been completed, the remaining candidate structures and their scoring details are output. Note that because the candidate structures have walked most (or perhaps all) of the MSⁿ tree, a vast amount of information has been collected about each candidate, for example, which disassembly pathways are consistent with which candidates. All of this additional information can also be presented to the user at the algorithm's conclusion.

The gtSequenceGrow can also be described as follows.
Begin with a high-order MSⁿ spectrum
Calculate the composition(s) represented by the spectrum pathway's terminal ion.
Calculate all possible configurations of this composition. These are the candidate structures.
Predict the fragments each candidate structure would produce if disassembled.
Score each candidate by matching each predicted fragment against the experimental spectrum. Scoring considerations may include:
   A high-abundance matching experimental peak should boost the candidate's score more than a low-abundance matching peak.
   A missing experimental peak penalizes the candidate's score.
   An experimental peak whose abundance is much lower than predicted also penalizes the candidate's score.
Discard candidates that fall below a threshold of acceptability. These candidates scored so poorly relative to their peers that they should not be given further consideration. Candidates may be discarded based upon their score, the percentage of predicted peaks that are missing or which have a much lower than expected relative abundance, or other indicators that the experimental data do not contain the expected fragments.
Pass the surviving candidates up the MSⁿ spectrum tree to be processed by the precursor spectrum.
Again determine possible composition of the spectrum pathway's terminal ion.
For each surviving candidate, add enough residues to meet the spectrum's target composition. Residue counts must be matched, but so too must scar types and counts. Each candidate may generate multiple new candidates in this round. Here, each candidate must be “grown”—hence the method name—from its incoming composition to the target composition. If there is more than one way to add residues and/or scars to get from the old candidate to the new composition, every possibility is tried, generating multiple candidates.
Again perform the fragment prediction, scoring and culling of the new candidates against the experimental spectrum. Pass the surviving candidates up the MSⁿ tree.
If the candidates reach a spectrum that has more than one product spectrum:
   For each candidate/product spectrum pair, determine if the candidate could produce a fragment matching the product spectrum. This can be done by following the same consistent/possibly consistent/inconsistent processing performed by gtIsoDetect.
      If the product spectra should be applied to a candidate, score the candidate on the way down the MSⁿ tree by performing the usual fragment prediction and scoring.
      Stop when the candidate structure reached a product spectrum with which it is not compatible, or when the bottom of the MSⁿ tree is reached.
      Update the candidate structure's score at the originating spectrum by considering the scores generated on the walk down the MSⁿ tree. Strong correspondence between the candidate and the MSⁿ tree will improve its score, and a weak correspondence will weaken it

Special Handling of Complementary Fragments:

If an MSⁿ spectrum has two product spectra that are complements of each other (that is, they appear to be two fragments that, if combined, would reform exactly the precursor ion), then special processing may be applied:
In this case, we have three spectra to consider: The precursor (P), complement 1 (C1) and complement 2 (C2).
Ensure that C1 and C2 have already been processed and generated candidate structures.
We may generate structures at P by forming all possible combinations of the C1 and C2 candidates. That is, instead of growing from C1's composition to P's by adding individual residues and scars, we instead grow from C1 to P by adding the entire candidate substructures generated by C2. This will greatly reduce the number of candidates considered.
When the MSⁿ root is reached and all down-tree processing is completed, the surviving candidates are reported as those that best fit the entirety of the MSⁿ data set.

Other features of the sequencing method include, but are not limited to, those described below.

All candidates can be stored at all spectra in the MSⁿ tree, so external intervention (by another algorithm/technique or a human analyst) is possible. For example, an external tool (or analyst) may prefer a given candidate over all others at a given spectrum. All other candidates could then be eliminated, and the algorithm could continue its processing from that point, bubbling new results up the tree. This interactivity will provide much benefit for users of this technique. A specific example is a database that maps experimental spectra to known substructures. That spectrum's “fingerprint” could be used to deduce the structure represented by the spectrum, and all other candidates could be removed from consideration.

Often a single m/z value may have multiple possible compositions. (For example, the m/z 1677.87 spectrum of has two isobaric [mass equivalent] composition possibilities: H₂N₄h and H₃N₃n.) Again, external intervention is possible here, where preferred compositions can be indicated, and undesirable compositions eliminated. The algorithm can continue its processing from that point. For this example, however, we only consider the starting composition H₃N₃n.

When deciding if a predicted peak is present in the spectrum, external intervention is possible. There are times when different isotopic envelopes overlap, or where the charge state of an ion is difficult to ascertain. In these and similar cases, an external tool or human analyst can be consulted to decide if the predicted peak is truly present, and if so, at what abundance. This interactivity produces large benefits to users of this technique.

The peaks that match each candidate/spectrum pair can be stored and made available as part of the algorithm's output. This provides valuable insight into which candidates are consistent with which subsets of the observed peaks. Importantly, the algorithm does not attempt to create all possible candidates for the full glycan. Instead, it only considers those candidates at MSⁿ level N that are a small “edit distance” away from those at level N+1. By limiting the number of candidates passed up at each step, the algorithm's performance is bounded.

The entire MSⁿ tree is considered, or put another way, none of the collected data are unjustly ignored. Going up the tree, candidates are created, scored, and culled; coming down the tree, their scores are refined.

gtSequenceAll

In select cases, it may desirable to generate the exhaustive set of candidate structures for a full glycan, herein referred to as “gtSequenceAll.” According to the methods of the invention, the “downward” phase of the gtSequenceGrow method can be used and each candidate can be scored against the entirety of the MSⁿ tree using the following sequence:
1) Accept as input (A) a set of MSⁿ spectra and (B) a glycan mass, m/z, or composition.
2) From the glycan's description, generate all possible candidate structures.
   a. Alternatively, all plausible structures may be generated from the glycan's description.
3) Initialize every candidate's score to the same value. (Or, optionally, score candidates on a continuous scale such that biosynthetically preferred candidates begin with higher scores and biosynthetically implausible candidates begin with lower scores.)
4) For each candidate/spectrum pair, determine if the candidate could produce a fragment matching the product spectrum. This can be done by following the same consistent/possibly consistent/inconsistent processing performed by gtIsoDetect as described herein.
   a. If the product spectra should be applied to a candidate, score the candidate on the way down the MSⁿ tree by performing the usual fragment prediction and scoring.
   b. Stop when the candidate structure reached a product spectrum with which it is not compatible, or when the bottom of the MSⁿ tree is reached.
   c. Update the candidate structure's score at the originating spectrum by considering the scores generated on the walk down the MSⁿ tree. Strong correspondence between the candidate and the MSⁿ tree will improve its score, and a weak correspondence will weaken it.
   d. Report each candidate and its score.
      gtSequenceConstrained

In other uses of the methods of the invention, upfront processing constrains the number of candidates to be considered, and those candidates are scored in a down-tree phase over the MSⁿ tree. This method is herein referred to as “gtSequenceConstrained.”

This method matches gtSequenceAll described above, with only a single change. Instead of “all possible/plausible candidate structures” in Step 2), the gtSequenceConstrained algorithm generates “a set of candidate structures that are (A) compatible with one or more disassembly pathways in the spectra and/or (B) compatible with presumed biosynthetic constraints and/or (C) consistent with a spectrum fingerprint of known glycans and/or (D) any other technique used to eliminate candidate structures as being too unlikely to merit further consideration.”

### Options and Parameters for the Sequencing and Isomer Detection Methods

Additional modifications of the aforementioned methods for glycan sequencing and isomer detection are possible. Exemplary, non-limiting modifications of these methods are described below.

The -ErrTolPPM and -ErrTolMZ Global Options

The -ErrTolPPM switch gives an error tolerance in parts per million (ppm); -ErrTolMZ gives an error tolerance in m/z units. When an experimental mass is used to retrieve possible compositions, all compositions in the larger of these error tolerance windows are considered.

The -NLinkedCore Global Option

When the -NLinkedCore global option is given, the methods of the invention will only consider structures that embed the N-linked core motif H₃Nn (Scheme 7). The structures will have all interresidue linkages assigned as well. This option may be given when the analyst is investigating the linkage of an N-glycan and wishes to assign residues to the 3- or 6-branch of the N-linked core.

The -NLinkedCoreBranching Global Option

The -NLinkedCoreBranching option is similar to -NLinkedCore with the exception that the interresidue linkages are not specified (although branching is specified). This option is used when the analyst is investigating branching topology only, and is not concerned with linkage assignments.

The -ReducingEndResidue Global Option

The -ReducingEndResidue option specifies which residues are eligible to be the reducing-end sugar of suggested structures. The supported option values are shown in Table 3. The default is -ReducingEndResidue any. Many examples in this work use -ReducingEndResidue reduced. The allowed option values are extended as additional residues are supported in the future.

TABLE 3

| Value | Selected Residue Types |
|---|---|
| Any | Any of HFSNhfn |
| Unreduced | Any of HFSN |
| Reduced | Any of hfn |
| Subset of | Selected residues, for example: |
| HFSNhfn | -ReducingEndResidue hn |

### Interactive Spectrum Annotation

Spectrum annotation is the process of assigning putative compositions to peaks observed on a mass spectrum. This step allows spectra to be interpreted by either an analyst or a computer algorithm or computer program. Prior to the present invention, there was no tool that performs this task interactively for MSⁿ spectra.

Analysts and algorithms must often convert the observed m/z values into putative compositions in order to attempt a structural analysis. The inherent complexity of having multiple MSⁿ spectra, with a tree of precursor and product spectra, can easily overwhelm an analyst—especially given the number of m/z peaks found on each spectrum. Providing interactive capabilities for annotating these spectra is advantageous in the structural analysis of molecules that include, for example, glycans.

The method for interactive spectra annotation described herein can allow the analyst to provide information to the system to reduce this complexity, and to guide the analyst to the most likely interpretations of the peaks on each spectrum. For example, the analyst can eliminate downstream compositions in order to facilitate analysis. One method that can be used to decide which downstream compositions can be eliminated is as follows.

Given a precursor/product composition pair, the residue types and counts are compared to determine if the product could have been generated from the precursor. When cleavage types and counts are available, as with permethylated glycans, the cleavage scars can also be used to rule out impossible precursor/product pairs.

An exemplary method for interactive labeling of spectra can include the following steps:
1) If a possible composition is eliminated for spectrum S:
   a. Propagate the elimination to all direct and indirect product spectra of S.
   b. For all modified spectra, propagate the elimination to each peak on the spectrum
2) If a possible composition is added to spectrum S (as, for example, when the analyst changes his mind and reverses an elimination):
   a. Recalculate the possible compositions for all direct and indirect product spectra of S.
   b. For all modified spectra, recalculate the possible compositions for all contained peaks.

The following examples are put forth so as to provide those of ordinary skill in the art with a complete disclosure and description of how the methods and compounds claimed herein are performed, made, and evaluated, and are intended to be purely exemplary of the invention and are not intended to limit the scope of what the inventors regard as their invention.

### EXAMPLES

### Example 1

### Fragmentation of Permethylated Glycans in Positive Experimental Mode

The below data show that some chemical bonds in permethylated glycans are considerably more likely to rupture (i.e., these bonds are more “labile”) than others, and therefore lead to predicable fragments when the glycans are analyzed via MSⁿ.

It has been well established that permethylated glycans tend to fragment most readily at the glycosidic bonds between residues, especially when the number of residues in the precursor fragment is, for example, four or more. A closer examination shows that certain permethylated residues form weaker glycosidic bonds, leading to a skewed distribution of fragment intensities on the experimental spectrum. That is, fragments formed by the rupture of weak bonds tend to occur with a higher relative abundance than fragments formed by the rupture of strong bonds.

Metal ion (Na+, K+, and Li+) and proton localization (or charge localization) in positive mode and electron delocalization in negative mode lead to predictable fragmentation patterns in mass spectrometers, allowing the algorithms to predict fragments correctly with high probability.

We can assign a rough “cost” to each bond, where larger numbers indicate increasingly strong bonds, and hence more costly to break. See, for example. Table 4.

TABLE 4

| Residue on the non-reducing | Type of Bond | Estimated Bond |
|---|---|---|
| side of the bond | Ruptured | Cleavage Cost |
| S | Inter-residue | 0 |
| N | Inter-residue | 0 |
| H | Inter-residue | 1 |
| F | Interresidue | 1 |
| Any | Cross-Ring | 2 |

These bond costs are approximate and can be optionally adjusted. For example, bond cleavage costs can depend upon factors that include, for example:
Both residues involved in the bond (e.g., H-H differs from H-N)
The linkage position of the bond (H1-4H differs from H1-6H)
The exact monosaccharides involved (e.g., Gal-Gal differs from Gal-Glc).
The number of bonds at a given residue (e.g., HHN differs from H(H)N because the N has either one or two connected residues)

These estimates give predictions that closely match the observed experimental results. Also important is the type of fragments generated when an inter-residue bond is broken. An oxygen atom is between each pair of residues, and the bond can break on either side of the oxygen (see the Domon and Costello A/X, B/Y, and C/Z ion type complements above). The methods of the invention predict which fragment types are expected to arise when bonds are ruptured as shown in Table 5.

TABLE 5

| Residue on the non-reducing | Predicted |
|---|---|
| side of the bond | Fragments |
| S | B, Y |
| N | B, Y |
| H | B, C, Y |
| F | B, C, Y |

Table 4 and Table 5 combine to predict the relative abundance and type of fragments generated during glycan disassembly. As such, they are the underpinnings of the methods for sequencing and isomer detection of the invention.

These predictions align with experimental data as described below.

Fragmentation of GM1a/GM1b

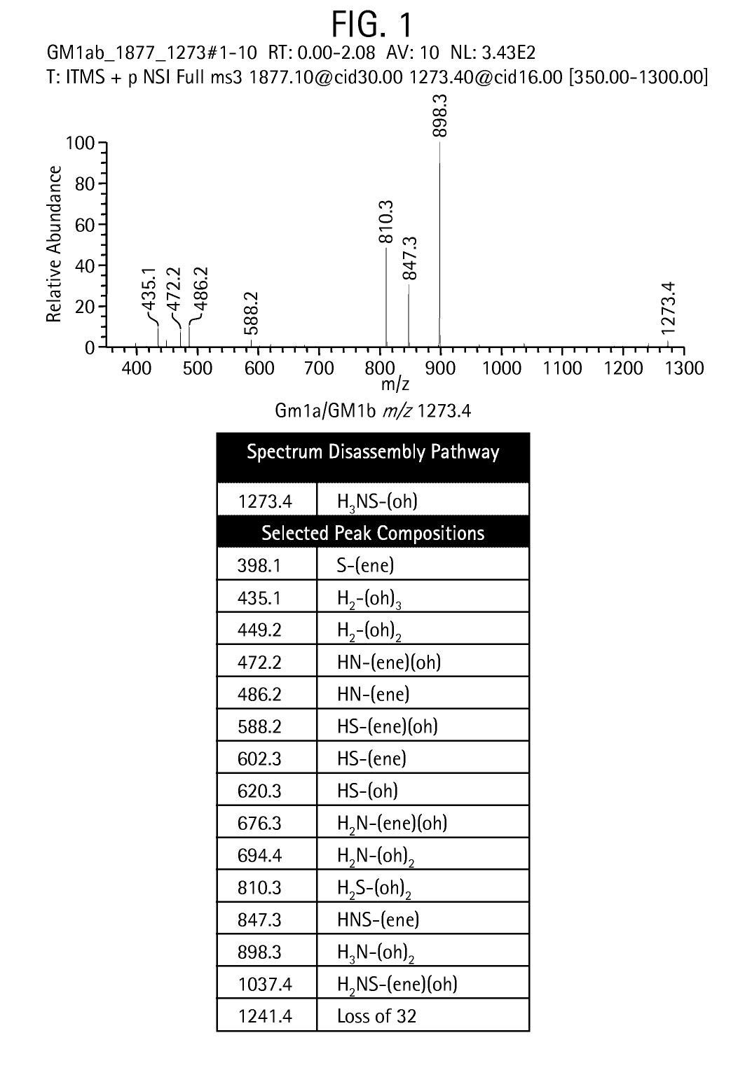

Scheme 8 shows the fragments expected to arise from the mixture of GM1a/GM1b glycans shown in FIG. 1, as predicted by Tables 4 and 5. The prediction is that the bonds originating from S and N residues, with a cleavage cost of zero, are the easiest to break, and will create complementary B-type (reducing-end-(ene)) and Y-type (non-reducing-end-(oh)) fragments. In the figure, we show the results of cleaving all S- and N-originated bonds, with appropriate ion fragment types generated. Note that many of the fragments arise from a single cleavage (ions m/z 486.2, 810.4, 398.1, 898.4, 847.4, and 449.2) whereas others result from double cleavages (ions m/z 435.1 and 472.2).

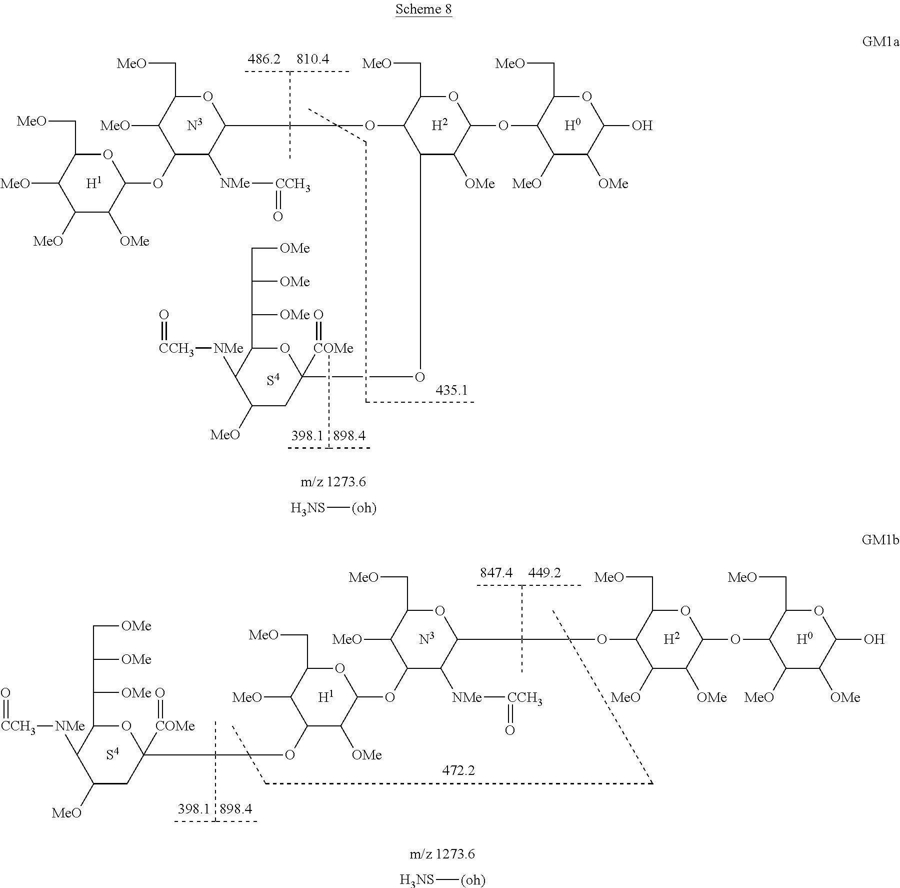

These predicted fragments are in close agreement with FIG. 1, as shown in Table 6. The predicted zero-cost cleavages include all of the highest-abundance fragments on the spectrum, with the exception of ion m/z 588.2. This ion has a relative intensity of only 4% and can be explained by residues S⁴ and H² from GM1a, extracted via a zero-cost and one-cost cleavage (a B/Y cleavage around H²).

TABLE 6

| | | Approx. Relative | Predicted by Zero- |
|---|---|---|---|
| m/z | Composition | Intensity (%) | Cost Cleavages? |
| 398.1 | S-(ene) | 2 | Y |
| 435.1 | H₂-(oh)₃ | 11 | Y |
| 449.2 | H₂-(oh)₂ | 4 | Y |
| 472.2 | HN-(ene)(oh) | 8 | Y |
| 486.2 | HN-(ene) | 11 | Y |
| 588.2 | HS-(ene)(oh) | 3.5 | N |
| 602.3 | HS-(ene) | 0.6 | N |
| 620.3 | HS-(oh) | 1.1 | N |
| 676.3 | H₂N-(ene)(oh) | 0.8 | N |
| 694.4 | H₂N-(oh)₂ | 0.5 | N |
| 810.3 | H₂S-(oh)₂ | 47 | Y |
| 847.3 | HNS-(ene) | 31 | Y |
| 898.3 | H₃N-(oh)₂ | 100 | Y |
| 1037.4 | H₂NS-(ene)(oh) | 1.5 | N |
| 1241.4 | Non-specific | 1.5 | N |
| | loss of 32 (OMe) | | |

Every predicted zero-cost fragment was found on the spectrum and in non-trivial abundance. These data support the contention that because the cost fragmentation scheme makes predictions that match experimental results.

### Fragmentation of Fetuin m/z 3618.81 (1820.9²⁺)

Fragmentation of the Intact Glycan

The fetuin glycan m/z 3618.81 (1820.9²⁺) is shown in Scheme 9, with a simplified representation in Scheme 10.

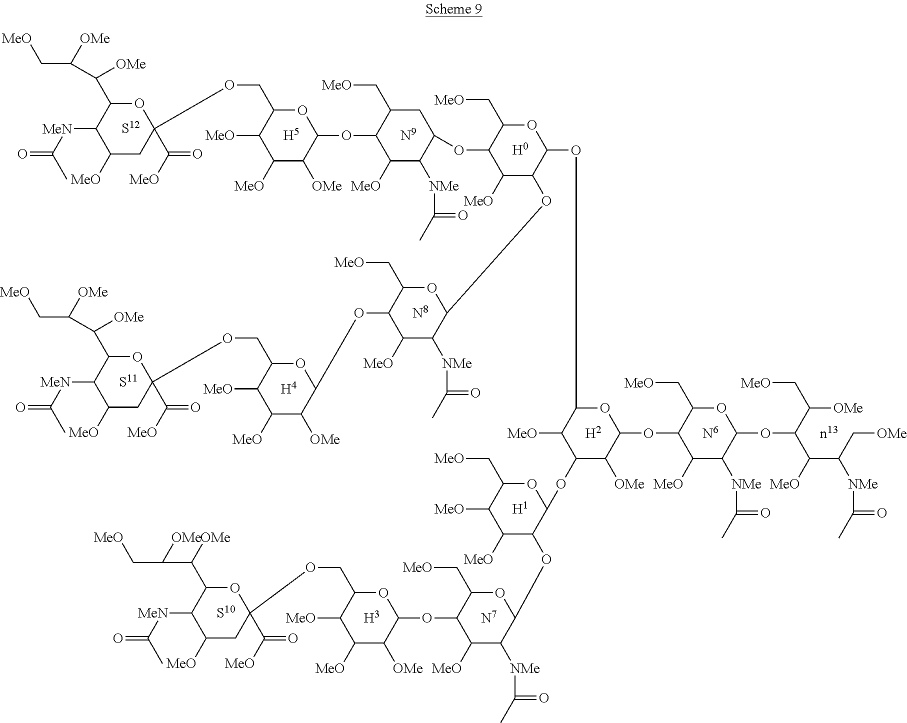

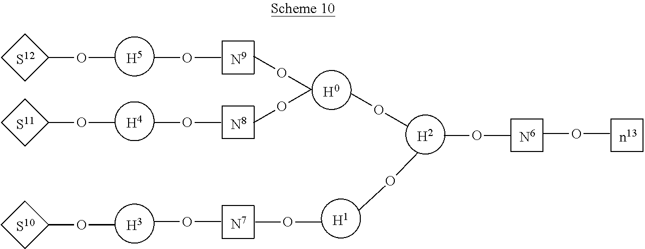

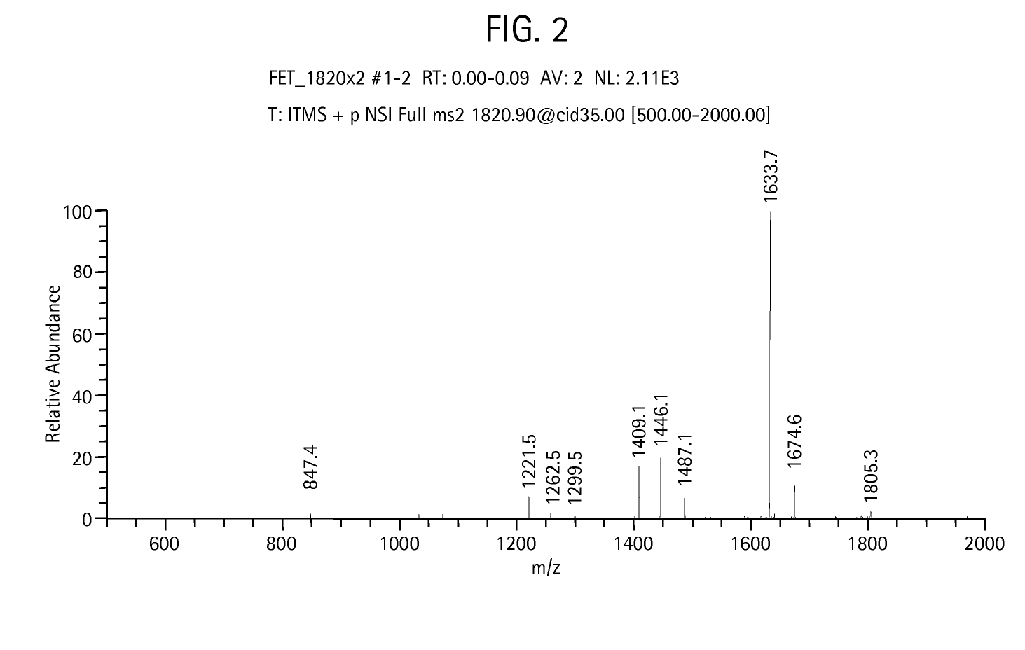

Table 7 lists the ions observed in FIG. 2. In some cases, the observed m/z listed is approximately 0.5 mass units smaller than shown on the spectrum in FIG. 2. This difference is due to the labeling of the second peak in the isotopic envelope when it is the most abundant. Because these ions are doubly-charged, the monoisotopic peak is 0.5 mass units lower.

TABLE 7

| | | Singly- | | | | Predicted |
|---|---|---|---|---|---|---|
| Observed | Charge | Charged | Most Likely | Theoreti- | | by Zero-Cost |
| m/z | State | m/z | Composition | cal m/z | Description | Cleavages? |
| 847.4 | +1 | 847.4 | HNS-(ene) | 847.41 | Any SHN antenna | Y |
| 1221.1 | +2 | 2419.21 | H₅N₃Sn-(oh)₂ | 2419.21 | Loss of SHN and | Y |
| | | | | | S | |
| 1258.1 | +2 | 2493.21 | H₆N₄n-(oh)₃ | 2493.25 | Loss of all three S | Y |
| 1262.0 | +2 | 2501.01 | H₅N₃S₂- | 2501.22 | Loss of SHN and | Y |
| | | | (ene)(oh) | | n | |
| 1299.1 | +2 | 2575.21 | H₆N₄S- | 2575.25 | Loss of two S and | Y |
| | | | (ene)(oh)₂ | | n | |
| 1408.6 | +2 | 2794.21 | H₅N₃S₂n-(oh) | 2794.40 | Loss of SHN | Y |
| 1445.6 | +2 | 2868.21 | H₆N₄Sn-(oh)₂ | 2868.44 | Loss of two S | Y |
| 1486.6 | +2 | 2950.21 | H₆N₄S₂- | 2950.44 | Loss of S and n | Y |
| | | | (ene)(oh) | | | |
| 1633.2 | +2 | 3243.41 | H₆N₄S₂n-(oh) | 3243.63 | Loss of S | Y |
| 1674.3 | +2 | 3325.61 | H₆N₄S₃-(ene) | 3325.63 | Loss of n | Y |

The rules set forth herein also correctly predict the cleavage types. For example, ion m/z 847.4 matches the predicted B-type (ene) cleavage to residues N⁷, N⁸ and/or N⁹, and the complementary Y-type (oh) ion is found at m/z 1408.6.

Sequential Fragmentation of an m/z 847.4 Antenna

As another example of predicting the fragmentation of permethylated glycans in positive mode, consider the m/z 847.4 antenna from the previous fetuin glycan shown in Scheme 11a. This example demonstrates the predictability of disassembly on substructures. Given the S-H-N-(ene) linear antenna, we would predict fragments as shown in Table 8.

TABLE 8

| Bond | | | Approx. Relative | Cost of Cleavage |
|---|---|---|---|---|
| Broken | m/z | Composition | Intensity (%) | Applied |
| Between | 398.1 | S-(ene) | 5 | 0 |
| S and H | 472.2 | HN-(ene)(oh) | 100 | |
| Between | 268.1 | N-(ene)(oh) | 0.35 | 1 |
| H and N | 602.3 | HS-(ene) | 0.38 | |
| | 620.3 | HS-(oh) | 2 | |

Again we see that, as predicted, rupturing lower-cost bonds yields fragments in greater abundance. As the precursor ion size shrinks (as measured by the number of contained residues), we are beginning to observe cross-ring fragments, specifically ions m/z 690.3, 486.2 and 315.1. These are shown Scheme 11b, 11c, and 11d, respectively.

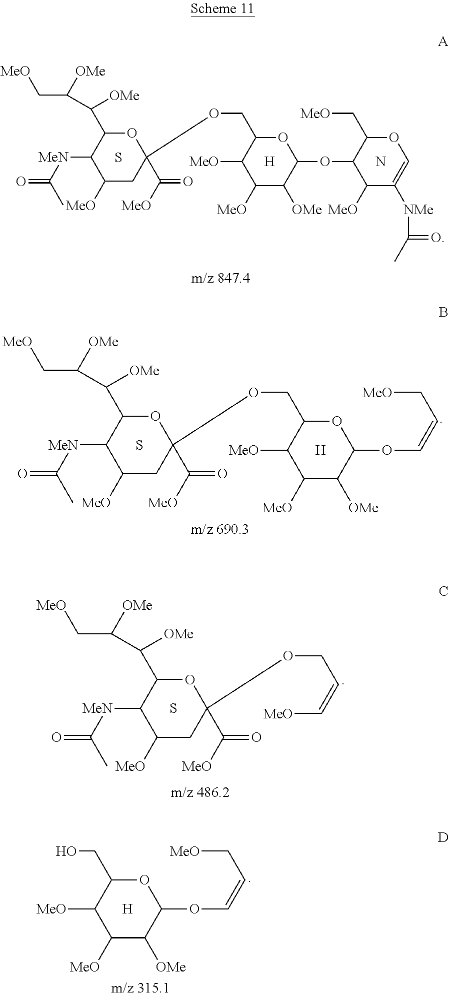

Fragmentation of Native Glycans in Negative Mode

The principles used to analyze glycans fragmented in positive mode can be adapted to the analysis of native glycans fragmented in negative mode. Unlike the B-, C-, and Y-type ions that dominate the positive mode spectra of permethylated glycans, native/negative spectra contain mainly A-type cross-ring fragments and C-type glycosidic fragments. Also observed in abundance are what are called “D ions,” which are in effect a combination of two cleavages (C and Z) applied to the same residue. Glycan fragmentation in negative mode is discussed in a series of papers by Harvey (J. Am. Soc. Mass. Spectrom., 16: 622-630 (2005); J. Am. Soc. Mass. Spectrom., 16: 631-646 (2005); and J. Am. Soc. Mass. Spectrom., 16: 647-659 (2005)), each of which is incorporated herein by reference.

In negative mode, a lack of “internal fragments” (fragments produced by cleavages at multiple sites) was observed. This result further serves to increase the predictability of native glycan fragmentation in negative mode.

The fragmentation predictability of native glycans in negative mode makes it an excellent fit for structural analysis according to the methods of the invention.

### Example 2

### The gtIsoDetect Algorithm Applied to Ovalbumin m/z 1677.8

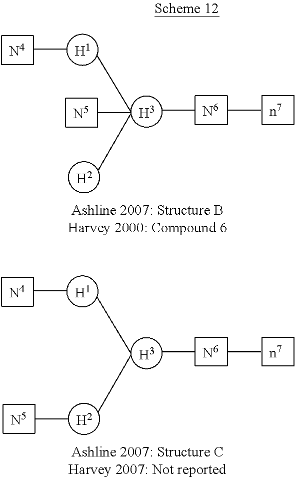

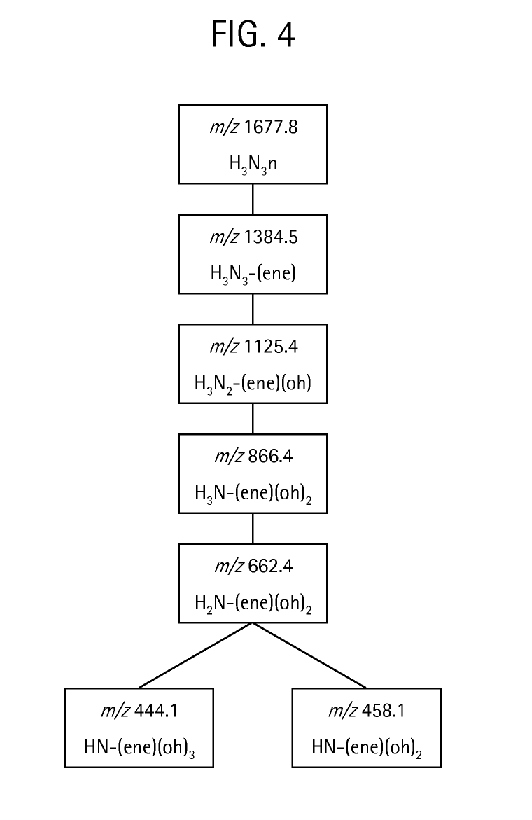

To illustrate the gtIsoDetect algorithm, we apply it to the concrete example of two isomeric glycans found in ovalbumin m/z 1677.8. The composition pathway used in this example are shown in FIG. 4 and the two isomeric structures under consideration—labeled B and C in accordance with Ashline et al, Anal Chem 79: 3830-3842 (2007)—are shown in Scheme 12.

Processing 1677.8→1384.5→1125.4→866.4→662.4→444.1

First we demonstrate how gtIsoDetect applies the m/z pathway 1677.8→1384.5→1125.4→866.4→662.4→444.1 to structures B and C. For both structures in parallel, substructures are sought that match the composition of each successive ion in the pathway as shown in Table 9.

TABLE 9

| | | Substructure Embed- | Substructure Embed- |
|---|---|---|---|
| m/z | Composition | ded in Structure B | ded in Structure C |
| 1677.8 | H₃N₃n | H¹H²H³N⁴N⁵N⁶n⁷ | H¹H²H³N⁴N⁵N⁶n⁷ |
| 1384.5 | H₃N₃-(ene) | H¹H²H³N⁴N⁵N⁶ | H¹H²H³N⁴N⁵N⁶ |
| 1125.4 | H₃N₂-(ene)(oh) | H¹H²H³N⁵N⁶ OR | H¹H²H³N⁵N⁶ OR |
| | | H¹H²H³N⁴N⁶ | H¹H²H³N⁴N⁶ |
| 866.4 | H₃N-(ene)(oh)₂ | H¹H²H³N⁶ | H¹H²H³N⁶ |
| 662.4 | H₂N-(ene)(oh)₂ | H²H³N⁶ OR | H²H³N⁶ OR |
| | | H¹H³N⁶ | H¹H³N⁶ |
| 444.1 | HN-(ene)(oh)₃ | H³N⁶ | Inconsistent |

As Table 9 shows, structure B is able to fulfill every ion in the pathway via a predicted cleavage. Cleaving above an N yields an (ene) scar and all non-reducing-end cleavages yield (oh) scars.

For m/z 1384.5, residue n⁷ is lost. For m/z 1125.4, a terminal N must be lost. In both structures, this is ambiguous, as either N⁴ or N⁵ can be lost, and so both alternatives are considered. In the very next step (m/z 866.4), however, the other terminal N is lost, eliminating any ambiguity. At m/z 662.4, an internal H is lost, which again is ambiguous as H¹ and H² are both acceptable choices.

m/z 444.1 differs between structures B and C. For B, the ion can be satisfied by the subtree H³N⁶, which contains the required (ene)(oh)₃ scars. The gtIsoDetect labels this structure/pathway pair as predicted. However, no such subtree exists within structure C. The corresponding H³N⁶ residues would contain only three scars when extracted from the full glycan, not the four scars demanded by the composition. As such, gtIsoDetect labels this structure/pathway pair as inconsistent.

Processing 1677.8→1384.5→1125.4→866.4→662.4→458.1

Next we demonstrate how gtIsoDetect applies the m/z pathway 1677.8→1384.5→1125.4→866.4→662.4→458.1 to structures B and C. This pathway is identical to the previous example, except the terminal ion is not m/z 444.1, but rather m/z 458.1, with a composition of HN-(ene)(oh)₂. Again, for both structures in parallel, substructures are sought that match the composition of each successive ion in the pathway. See Table 10.

TABLE 10

| | | Substructure Embed- | Substructure Embed- |
|---|---|---|---|
| m/z | Composition | ded in Structure B | ded in Structure C |
| 1677.8 | H₃N₃n | H¹H²H³N⁴N⁵N⁶n⁷ | H¹H²H³N⁴N⁵N⁶n⁷ |
| 1384.5 | H₃N₃-(ene) | H¹H²H³N⁴N⁵N⁶ | H¹H²H³N⁴N⁵N⁶ |
| 1125.4 | H₃N₂-(ene)(oh) | H¹H²H³N⁵N⁶ OR | H¹H²H³N⁵N⁶ OR |
| | | H¹H²H³N⁴N⁶ | H¹H²H³N⁴N⁶ |
| 866.4 | H₃N-(ene)(oh)₂ | H¹H²H³N⁶ | H¹H²H³N⁶ |
| 662.4 | H₂N-(ene)(oh)₂ | H²H³N⁶ OR | H²H³N⁶ OR |
| | | H¹H³N⁶ | H¹H³N⁶ |
| 458.1 | HN-(ene)(oh)₂ | Inconsistent | H³N⁶ |

The processing is unchanged until the final ion. Here, the HN-(ene)(oh)₂ composition cannot be satisfied by structure B, because the H³N⁶ substructure can be extracted with four cleavages, not the required three. Structure B is therefore labeled as inconsistent with this m/z pathway. However, structure C is able to satisfy all losses with predicted cleavages, and so is labeled consistent.

Processing 1677.8→1384.5→1125.4→866.4→662.4→444.1→250.1

Next we demonstrate how gtIsoDetect applies the m/z pathway 1677.8→1384.5→1125.4→866.4→662.4→444.1→250.1 to structures B and C. Ion m/z 250.1 appears on the experimental spectrum of ion m/z 444.1, data not shown. This pathway is identical to the first example, except the new terminal ion m/z 250.1 has been added, with a composition of N-(ene)₂. Again, for both structures in parallel, substructures are sought that match the composition of each successive ion in the pathway. See Table 11.

TABLE 11

| | | Substructure Embed- | Substructure Embed- |
|---|---|---|---|
| m/z | Composition | ded in Structure B | ded in Structure C |
| 1677.8 | H₃N₃n | H¹H²H³N⁴N⁵N⁶n⁷ | H¹H²H³N⁴N⁵N⁶n⁷ |
| 1384.5 | H₃N₃-(ene) | H¹H²H³N⁴N⁵N⁶ | H¹H²H³N⁴N⁵N⁶ |
| 1125.4 | H₃N₂-(ene)(oh) | H¹H²H³N⁵N⁶ OR | H¹H²H³N⁵N⁶ OR |
| | | H¹H²H³N⁴N⁶ | H¹H²H³N⁴N⁶ |
| 866.4 | H₃N-(ene)(oh)₂ | H¹H²H³N⁶ | H¹H²H³N⁶ |
| 662.4 | H₂N-(ene)(oh)₂ | H²H³N⁶ OR | H²H³N⁶ OR |
| | | H¹H³N⁶ | H¹H³N⁶ |
| 444.1 | HN-(ene)(oh)₃ | H³N⁶ | Inconsistent |
| 250.1 | N-(ene)₂ | N⁶ | <Not Processed> |

Here, ion m/z 250.1 can be satisfied by structure B, but not by using only predicted fragmentation. The composition of this ion, N-(ene)₂, requires an (ene) scar on the non-reducing side of the N residue. This Z-type ion is not predicted; however, it is a logical possibility and so this pathway/structure pair is labeled as possibly consistent. The unsure nature of this assignment is therefore flagged for inspection by the analyst.

Also note that ion m/z 250.1 is not processed for structure C. Because the precursor ion m/z 444.1 is inconsistent with the structure, processing stops and the pathway/structure pair is labeled as inconsistent.

Summary of gtlsoDetect Results

Table 12 gives a summary of the gtIsoDetect output for the six examined pathway/structure pairs. The highlighted entries would be suitable for further investigation by the analyst.

TABLE 12

| m/z pathway | Structure B | Structure C |
|---|---|---|
| 1677.8 → 1384.5 → 1135.4 → | Predicted | Inconsistent |
| 866.4 → 662.4 → 444.1 | | |
| 1677.8 → 1384.5 → 1135.4 → | Inconsistent | Predicted |
| 866.4 → 662.4 → 458.1 | | |
| 1677.8 → 1384.5 → 1135.4 → | Possibly Consistent | Inconsistent |
| 866.4 → 662.4 → 444.1 → 250.1 | | |

### Example 3

### gtSequenceGrow for Glycan Sequencing

In this Example, we use the gtSequenceGrow method to assign a glycan topology. These data were collected via MSⁿ, but this technique can be applied to any technology that fragments glycans in a predictable step-wise manner such as, for example, with a series of glycosidase digests interleaved with MS/MS analysis.

Processing follows the chart of FIG. 3. We begin processing at the terminal spectrum m/z 458.1. The example is slightly simplified in that m/z 1677.7 has two possible compositions—H₃N₃n or H₂N₄h—but we exclude the second possibility because the MS³ spectrum (m/z 13384.5) is consistent with only the first. gtSequenceGrow is applied according to the following manner:

### Simulate m/z 458.1/HN-(ene)(oh)₂

Create all substructure matching compositions without scars (Scheme 13).

### Scheme 13

1) H—N
2) N—H
Add all combinations of scars. (Scheme 14).

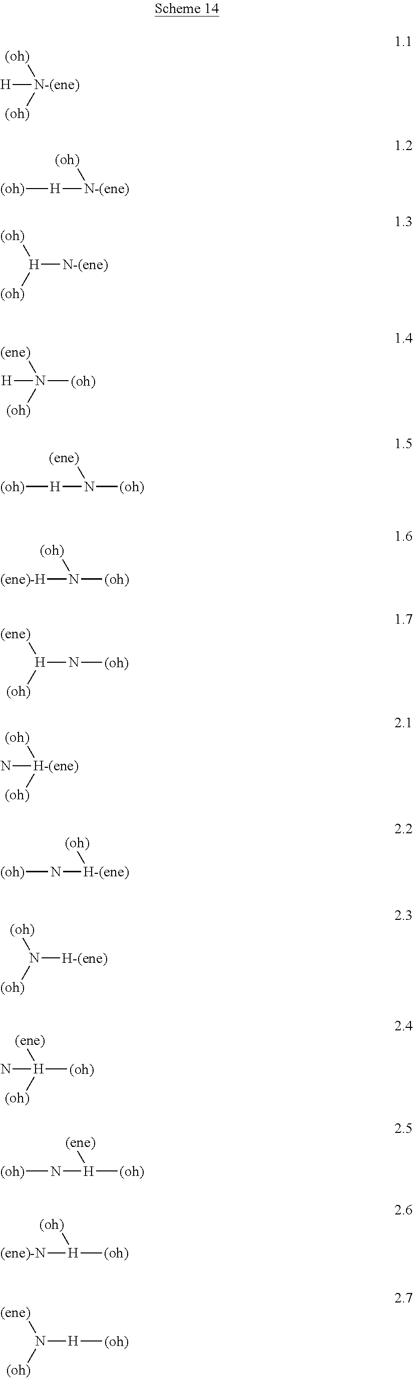

The structure numbering scheme is according to the following guidelines: when structure X is modified to create successors, the successors are labeled X.1, X.2, X.3, and so on. This has the advantage of recording the full lineage of all structures produced. For example, a structure 1.2.3.4 is necessarily the fourth modification of structure 1.2.3, which in turn came from structure 1.2.
Note that substructures with no scar at the reducing end are not considered. This is because we know the target composition (H₃N₃n) contains a reduced residue (n). Because these substructures do not have a reducing-end n residue, a scar must be left for that residue to eventually find its way to the reducing end.
Next, we fragment these substructures according to the guidelines described above in Table 4 and Table 5 (Scheme 15).

### Scheme 15

1.1 H-(oh), H-(ene), N-(ene)(oh)₃ [1]
1.2 H-(oh)₂, H-(ene)(oh), N-(ene)(oh)₂ [1]
1.3 H-(oh)₃, H-(ene)(oh)₂, N-(ene)(oh) [1]
1.4 H-(oh), H-(ene), N-(ene)(oh)₃ [1]
1.5 H-(oh)₂, H-(ene)(oh), N-(ene)(oh)₂ [1]
1.6 H-(ene)(oh), H-(ene)₂, N-(oh)₃ [1]
1.7 H-(ene)(oh)₂, H-(ene)₂(oh), N-(oh)₂ [1]
2.1 N-(ene), H-(ene)(oh)₃ [0]
2.2 N-(ene)(oh), H-(ene)(oh)₂ [0]
2.3 N-(ene)(oh)₂, H-(ene)(oh) [0]
2.4 N-(ene), H-(ene)(oh)₃ [0]
2.5 N-(ene)(oh), H-(ene)(oh)₂ [0]
2.6 N-(ene)₂, H-(oh)₃ [0]
2.7 N-(ene)₂(oh), H-(oh)₂ [0]
   The numbers in square brackets indicate the cost of each bond ruptured to generate the fragment
Score all substructures (Table 13) in order to propagate highest scoring substructures to precursor spectrum.
   Here, we consult the calculated intensity sums for each proposed substructure. A highlighted “X” indicates a complete lack of any ion at the specified m/z value. So, for example, all of the predicted ions for structure 1.1, namely m/z 259.11/H-(oh), 241.10/H-(ene), and 240.09/N-(ene)(oh)₃, are missing from the m/z 458.1 spectrum.

TABLE 13

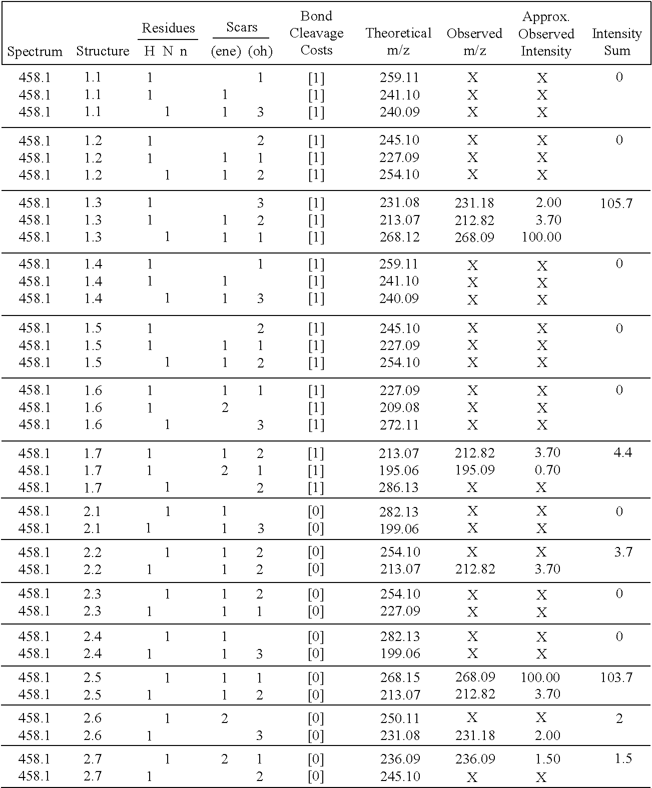

Structures 1.3 and 2.5 are clearly the strongest candidates and are propagated to the precursor spectrum (Scheme 16). These two candidates are selected for advancement here, as they are clearly the highest scoring, but the algorithm is free to propagate more, for example, 3, 4, 5, or 6 candidates, when multiple scores are close.

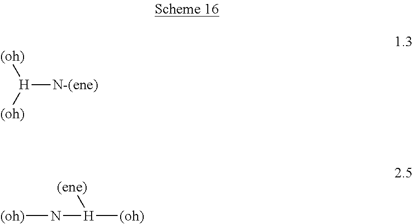

### Simulate m/z 662.41/H₂N-(ene)(oh)₂

Grow structures 1.3 and 2.5 to reach the target composition, ignoring scars for now (Scheme 17). New H residue is marked with a prime.

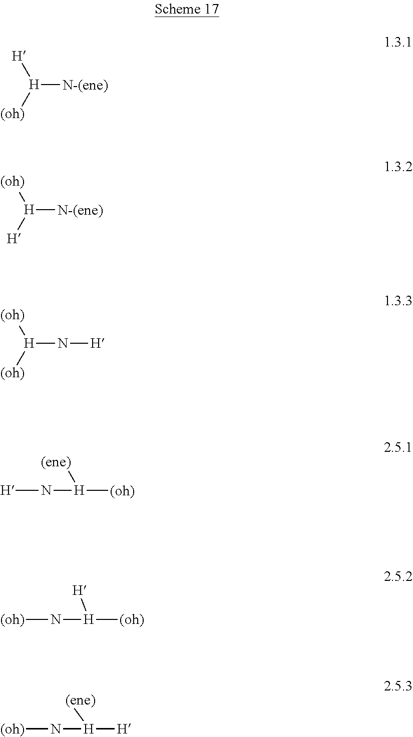

Here we are growing the candidates from the previous spectrum to match the composition of the m/z 662.4 spectrum, H₂N-(ene)(oh)₂. New residues can be added only in locations currently occupied by scars, or to other residues added in this step. Also note that multiple residues may be added in this step.
Add scars to reach target composition. This means we must add one (oh) scar.
Scars may only be added to the residues added in this round (i.e., the residues marked with a prime)
Substructures with no reducing end scar are not considered as we know that the reducing end residue must be n₁ (Scheme 18). This optional optimization greatly increases the algorithm's performance.

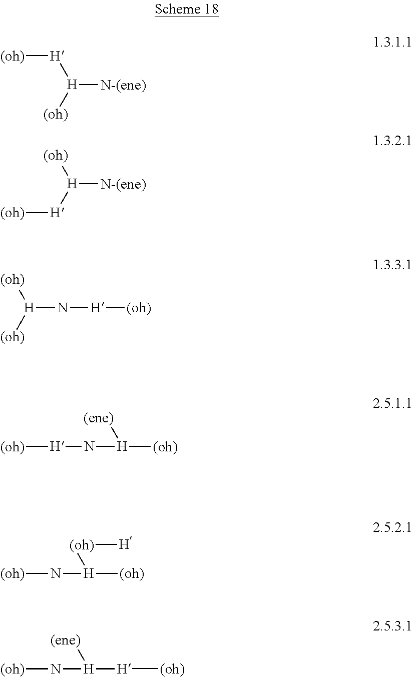

When adding scars to bring substructures to complete agreement with the target composition, scars may only be added to the residues added in this round. If there is more than one way to add scars to reach the target composition, a candidate is created for each possibility.
Eliminate 1.3.2.1 as a duplicate of 1.3.1.1 and predict Fragments for the remaining structures (Scheme 19)
   We eliminate structure 1.3.2.1 as a duplicate of 1.3.1.1 because they have the same topology. However, if in this example the algorithm were considering linkage, and 1.3.2.1 differed in linkage from 1.3.1.1, they would not be duplicates and both would be evaluated as independent candidates.

### Scheme 19

1.3.1.1 H-(ene)(oh), H-(oh)₂, HN-(ene)(oh)₂ [1]
   H₂-(ene)(oh)₂, H₂-(oh)₃, N-(ene)(oh) [1]
1.3.3.1 H-(ene)(oh)₂, H-(oh)₃, HN-(oh)₂ [1]
   HN-(ene)(oh)₂, H-(oh)₂ [0]
2.5.1.1 H-(ene)(oh), H-(oh)₂, HN-(ene)(oh)₂ [1]
   HN-(ene)(oh), H-(ene)(oh)₂ [0]
2.5.2.1 N-(ene)(oh), H₂-(oh)₃, [0]
   H-(ene)(oh), H-(oh)₂, HN-(oh)₃ [1]
2.5.3.1 N-(ene)(oh), H₂-(ene)(oh)₂ [0]
   HN-(ene)₂(oh), HN-(ene)(oh)₂, H-(oh)₂ [1]
Score all substructures (Table 14).

TABLE 14

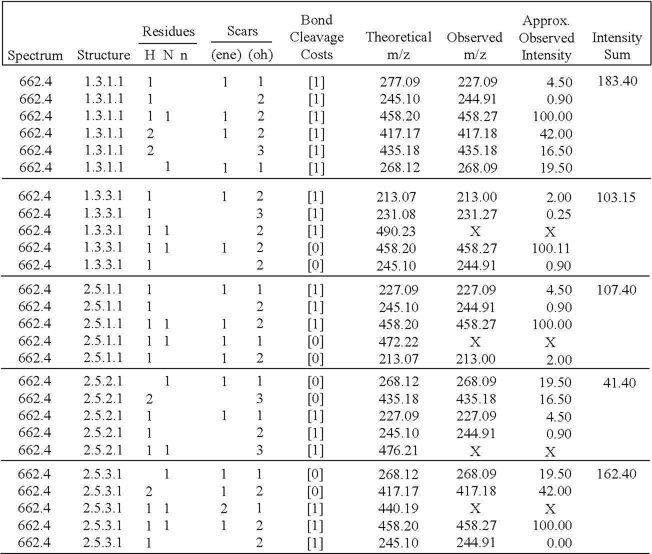

The highest scoring structures are 1.3.1.1 and 2.5.3.1. These propagate up to the precursor spectrum m/z 866.45.
A word here on penalties. As shown by the highlighted Xs in Table 14, all candidates other than 1.3.1.1 have “missing” ions. This should lead to substantial penalties on these candidates.
   One penalty scheme includes a reduction in score by 25% for a missing [0] fragment and 10% for a missing [1] fragment.
   Other penalty schemes can be based upon not only the predicted cost to rupture bonds (as in the 25%/10% example above), but also in the number of bonds ruptured to generate the fragment, or the sum of the costs of the bonds ruptured, and so on. Another useful scoring technique is the application of a penalty when a fragment predicted to have high abundance but is found experimentally to have low abundance. Many scoring modifications are possible here and are useful in the methods of the invention.
In this example, we always rupture a single bond to predict fragments (and in fact rupture each glycosidic bond exactly once in turn), but other fragment prediction strategies are possible, including
   (1) applying multiple glycosidic cleavages, especially combinations of low-cost cleavages;
   (2) cross-ring cleavages;
   (3) other well-defined cleavages (e.g., the loss of N-acetyl groups)
      These are all possible extensions of the core algorithm which can be performed by one skilled in the art, and so, for clarity, are not illustrated by this example.

### Simulate m/z 866.45/H₃N-(ene)(oh)₂

Grow structures 1.3.1.1 and 2.5.3.1 to reach the target composition (Scheme 20).
In this instance, we add scars immediately instead of in a separate step
The new H residue is marked with a prime.

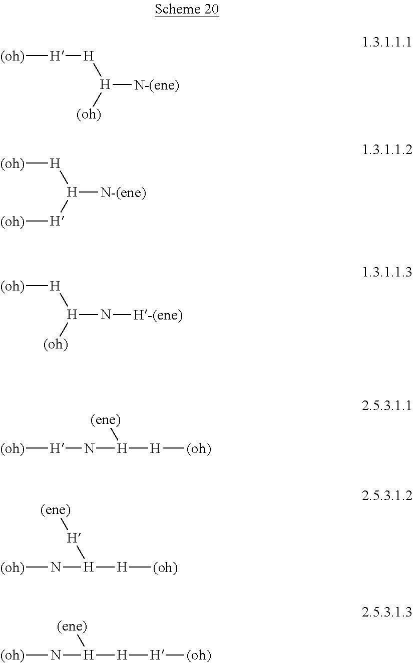

To compress the presentation, we now add residues and scars simultaneously when growing candidate substructures to match the precursor spectrum's composition.
Predict fragments for all structures (Scheme 21).

### Scheme 21

1.3.1.1.1 H-(ene)(oh), H-(oh)₂, H₂N-(ene)(oh)₂ [1]
   H₂-(ene)(oh), H₂-(oh)₂, HN-(ene)(oh)₂ [1]
   H₃-(ene)(oh)₂, H₃-(oh)₃, N-(ene)(oh) [1]
1.3.1.1.2 H-(ene)(oh), H-(oh)₂, H₂N-(ene)(oh)₂ [1]
   H₃-(ene)(oh)₂, H₃-(oh)₃, N-(ene)(oh) [1]
1.3.1.1.3 H-(ene)(oh), H-(oh)₂, H₂N-(ene)(oh)₂ [1]
   H₂-(ene)(oh)₂, H₂-(oh)₃, HN-(ene)(oh) [1]
   H₂N-(ene)(oh)₂, H-(ene)(oh) [0]
2.5.3.1.1 H-(ene)(oh), H-(oh)₂, H₂N-(ene)(oh)₂ [1]
   HN-(ene)(oh), H₂-(ene)(oh)₂ [0]
   H₂N-(ene)₂(oh), H₂N-(ene)(oh)₂, H-(oh)₂ [1]
2.5.3.1.2 N-(ene)(oh), H₃-(ene)(oh)₂ [0]
   H-(ene)₂, H-(ene)(oh), H₂N-(oh)₃ [1]
   H₂N-(ene)₂(oh), H₂N-(ene)(oh)₂, H-(oh)₂ [1]
2.5.3.1.3 N-(ene)(oh), H₃-(ene)(oh)₂ [0]
   HN-(ene)₂(oh), HN-(ene)(oh)₂, H₂-(oh)₂ [1]
   H₂N-(ene)₂(oh), H₂N-(ene)(oh)₂, H-(o¹¹)₂ [1]
Score all structures (see Table 15)
   The highest scoring structures are 1.3.1.1.2, 1.3.1.1.3, and 2.5.3.1.3
   Propagate these structures to the precursor spectrum

TABLE 15

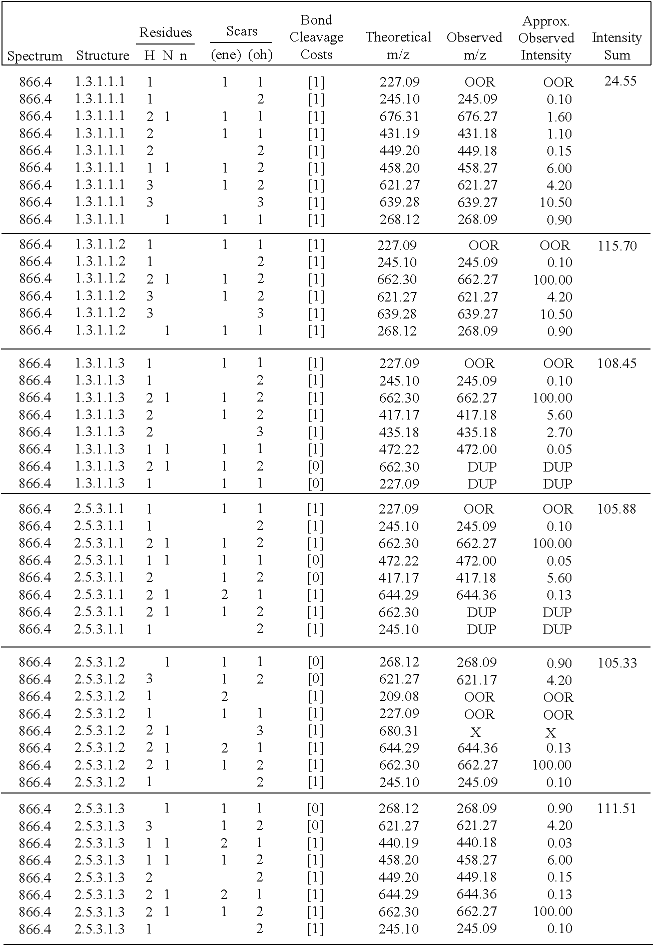

A word on scoring is appropriate.
   In Table 15, notice the entries eight highlighted entries in the “Theoretical m/z” column. These represent duplicate ions, that is, ions that are produced from more than one location in the precursor structure. When duplicates arise, we consider them only once. So, for example, ion m/z 662.3 for structure 1.3.1.1.3 does not contribute its observed peak intensity twice. Similarly, a missing duplicate ion would not penalize its candidate structure multiple times.
   In the “Observed m/z” column we also see entries labeled “OOR”. This stands for “Out Of Range”. On the instrument used to collect these data, namely a Thermo LTQ, the m/z spectrum does not extend all the way down to zero, but rather starts at some fraction of the m/z of precursor ion. Predicted ions that are outside this range are labeled OOR and do not affect scoring in any way.
      Simulate m/z 1125.38/H₃N₂-(ene) (oh)
Grow structures 1.3.1.1.2, 1.3.1.1.3, and 2.5.3.1.3 to reach the target composition (Scheme 22).
Here, we add a terminal N to occupy an (oh) scar. This follows from the change in composition from m/z 866 to m/z 1125
The new N is marked with a prime

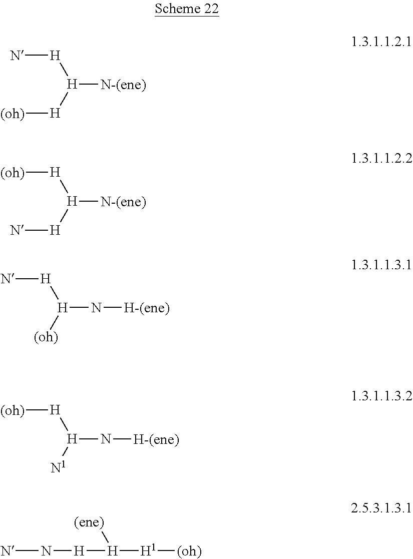

Eliminate 1.3.1.1.2.2 as a duplicate of 1.3.1.1.2.1
Predict fragments for all structures (Scheme 23).

### Scheme 23

1.3.1.1.2.1 N-(ene), H₃N-(ene)(oh)₂ [0]
   HN-(ene), HN-(oh), H₂N-(ene)(oh)₂ [1]
   H-(ene)(oh), H-(oh)₂, H₂N₂-(ene)(oh) [1]
   H₃N-(ene)(oh), H₃N-(oh)₂, N-(ene)(oh) [1]
1.3.1.1.3.1 N-(ene), H₃N-(ene)(oh)₂ [0]
   HN-(ene), HN-(oh), H₂N-(ene)(oh)₂ [1]
   H₂N-(ene)(oh), H₂N-(oh)₂, HN-(ene)(oh) [1]
   H₂N₂-(ene)(oh), H-(ene)(oh) [0]
1.3.1.1.3.2 H-(ene)(oh), H-(oh)₂, H₂N₂-(ene)(oh) [1]
   N-(ene), H₃N-(ene)(oh)₂ [0]
   H₂N-(ene)(oh), H₂N-(oh)₂, HN-(ene)(oh) [1]
   H₂N₂-(ene)(oh), H-(ene)(oh) [0]
2.5.3.1.3.1 N-(ene), H₃N-(ene)(oh)₂ [0]
   N₂-(ene), H₃-(ene)(oh)₂ [0]
   HN₂-(ene)₂, HN₂-(ene)(oh), H₂-(oh)₂ [1]
   H₂N₂-(ene)₂, H₂N₂-(ene)(oh), H-(oh)₂ [1]
Score all structures (see Table 16)
   The highest scoring structures are 1.3.1.1.2.1, 1.3.1.1.3.1, and 1.3.1.1.3.2. Propagate these structures to the precursor spectrum
   A note on scoring. Structure 2.5.3.1.3.1 has an Intensity Sum of 111.64, which is third highest of the four structures. Why was it excluded, instead of 1.3.1.1.3.2, with its score of 111.13? Notice that 2.5.3.1.3.1 has two missing ions, m/z 527.26 and 699.33. These would both apply substantial penalties to the structure's score, especially considering that m/z 527.26 was the result of a single zero-cost bond rupture, and should be quite abundant. As suggested previously, one scoring scheme would have these two missing ions penalize the overall score by 25% and 10%, respectively.

TABLE 16

| | | | | | | | Bond | | | Approx. | |
|---|---|---|---|---|---|---|---|---|---|---|---|
| | | Residues | | | Scars | | Cleavage | Theoretical | Observed | Observed | Intensity |
| Spectrum | Structure | H | N | n | (ene) | (oh) | Costs | m/z | m/z | Intensity | Sum |
| 1125.4 | 1.3.1.1.2.1 | | 1 | | 1 | | [0] | 282.13 | OOR | OOR | 135.86 |
| 1125.4 | 1.3.1.1.2.1 | 3 | 1 | | 1 | 2 | [0] | 866.40 | 866.36 | 100.00 | |
| 1125.4 | 1.3.1.1.2.1 | 1 | 1 | | 1 | | [1] | 486.23 | 486.18 | 0.33 | |
| 1125.4 | 1.3.1.1.2.1 | 1 | 1 | | | 1 | [1] | 504.24 | 504.14 | 0.13 | |
| 1125.4 | 1.3.1.1.2.1 | 2 | 1 | | 1 | 2 | [1] | 662.30 | 662.27 | 18.00 | |
| 1125.4 | 1.3.1.1.2.1 | 1 | | | 1 | 1 | [1] | 227.09 | OOR | OOR | |
| 1125.4 | 1.3.1.1.2.1 | 1 | | | | 2 | [1] | 245.10 | OOR | OOR | |
| 1125.4 | 1.3.1.1.2.1 | 2 | 2 | | 1 | 1 | [1] | 921.44 | 921.45 | 10.00 | |
| 1125.4 | 1.3.1.1.2.1 | 3 | 1 | | 1 | 1 | [1] | 880.41 | 880.36 | 3.20 | |
| 1125.4 | 1.3.1.1.2.1 | 3 | 1 | | | 2 | [1] | 898.42 | 898.36 | 4.20 | |
| 1125.4 | 1.3.1.1.2.1 | | 1 | | 1 | 1 | [1] | 268.12 | OOR | OOR | |
| 1125.4 | 1.3.1.1.3.1 | | 1 | | 1 | | [0] | 282.13 | OOR | OOR | 129.59 |
| 1125.4 | 1.3.1.1.3.1 | 3 | 1 | | 1 | 2 | [0] | 866.40 | 866.36 | 100.00 | |
| 1125.4 | 1.3.1.1.3.1 | 1 | 1 | | 1 | | [1] | 486.23 | 486.18 | 0.33 | |
| 1125.4 | 1.3.1.1.3.1 | 1 | 1 | | | 1 | [1] | 504.24 | 504.14 | 0.13 | |
| 1125.4 | 1.3.1.1.3.1 | 2 | 1 | | 1 | 2 | [1] | 662.30 | 662.27 | 18.00 | |
| 1125.4 | 1.3.1.1.3.1 | 2 | 1 | | 1 | 1 | [1] | 676.31 | 676.27 | 0.75 | |
| 1125.4 | 1.3.1.1.3.1 | 2 | 1 | | | 2 | [1] | 694.32 | 694.36 | 0.24 | |
| 1125.4 | 1.3.1.1.3.1 | 1 | 1 | | 1 | 1 | [1] | 472.22 | 472.27 | 0.14 | |
| 1125.4 | 1.3.1.1.3.1 | 2 | 2 | | 1 | 1 | [0] | 921.44 | 921.45 | 10.00 | |
| 1125.4 | 1.3.1.1.3.1 | 1 | | | 1 | 1 | [0] | 227.09 | OOR | OOR | |
| 1125.4 | 1.3.1.1.3.2 | 1 | | | 1 | 1 | [1] | 227.09 | OOR | OOR | 111.13 |
| 1125.4 | 1.3.1.1.3.2 | 1 | | | | 2 | [1] | 245.10 | OOR | OOR | |
| 1125.4 | 1.3.1.1.3.2 | 2 | 2 | | 1 | 1 | [1] | 921.44 | 921.45 | 10.00 | |
| 1125.4 | 1.3.1.1.3.2 | | 1 | | 1 | | [0] | 282.13 | OOR | OOR | |
| 1125.4 | 1.3.1.1.3.2 | 3 | 1 | | 1 | 2 | [0] | 866.40 | 866.36 | 100.00 | |
| 1125.4 | 1.3.1.1.3.2 | 2 | 1 | | 1 | 1 | [1] | 676.31 | 676.27 | 0.75 | |
| 1125.4 | 1.3.1.1.3.2 | 2 | 1 | | | 2 | [1] | 694.32 | 694.36 | 0.24 | |
| 1125.4 | 1.3.1.1.3.2 | 1 | 1 | | 1 | 1 | [1] | 472.22 | 472.27 | 0.14 | |
| 1125.4 | 1.3.1.1.3.2 | 2 | 2 | | 1 | 1 | [0] | 921.44 | DUP | DUP | |
| 1125.4 | 1.3.1.1.3.2 | 1 | | | 1 | 1 | [0] | 227.09 | DUP | DUP | |
| 1125.4 | 2.5.3.1.3.1 | | 1 | | 1 | | [0] | 282.13 | OOR | OOR | 111.64 |
| 1125.4 | 2.5.3.1.3.1 | 3 | 1 | | 1 | 2 | [0] | 866.40 | 866.36 | 100.00 | |
| 1125.4 | 2.5.3.1.3.1 | | 2 | | 1 | | [0] | 527.26 | X | X | |
| 1125.4 | 2.5.3.1.3.1 | 3 | | | 1 | 2 | [0] | 621.27 | 621.27 | 1.60 | |
| 1125.4 | 2.5.3.1.3.1 | 1 | 2 | | 2 | | [1] | 699.33 | X | X | |
| 1125.4 | 2.5.3.1.3.1 | 1 | 2 | | 1 | 1 | [1] | 717.34 | 717.09 | 0.01 | |
| 1125.4 | 2.5.3.1.3.1 | 2 | | | | 2 | [1] | 449.20 | 449.45 | 0.02 | |
| 1125.4 | 2.5.3.1.3.1 | 2 | 2 | | 2 | | [1] | 903.43 | 903.36 | 0.01 | |
| 1125.4 | 2.5.3.1.3.1 | 2 | 2 | | 1 | 1 | [1] | 921.44 | 921.45 | 10.00 | |
| 1125.4 | 2.5.3.1.3.1 | 1 | | | | 2 | [1] | 245.10 | OOR | OOR | |

Simulate m/z 1384.50/H₃N₃-(ene)
Grow structures 1.3.1.1.2.1, 1.3.1.1.3.1, and 1.3.1.1.3.2 to reach the target composition (Scheme 24).
From the precursor and product compositions, we add a terminal N to occupy an (oh) scar.
The new N is marked with a prime.

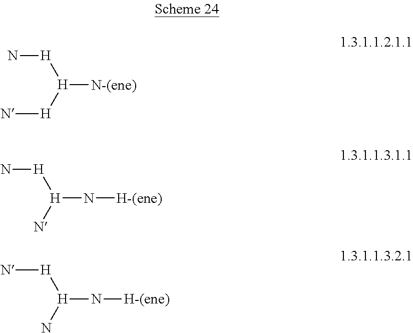

Eliminate 1.3.1.1.3.2.1 as a duplicate of 1.3.1.1.3.1.1.
Predict fragments for all structures (Scheme 25).

### Scheme 25

1.3.1.1.2.1.1 N-(ene), H₃N₂-(ene)(oh) [0]
   HN-(ene), HN-(oh), H₂N₂-(ene)(oh) [1]
   H₃N₂-(ene), H₃N₂-(oh), N-(ene)(oh) [1]
1.3.1.1.3.1.1 N-(ene), H₃N₂-(ene)(oh) [0]
   HN-(ene), HN-(oh), H₂N₂-(ene)(oh) [1]
   H₂N₂-(ene), H₂N₂-(oh), HN-(ene)(oh) [1]
   H₂N₃-(ene), H-(ene)(oh) [0]
Score all structures (Table 17).
   Structure 1.3.1.1.2.1.1 is superior to 1.3.1.1.3.1.1 but both will be propagated to see if they can be further distinguished from one another and to demonstrate the down-tree processing of the algorithm
      Alternatively, the penalties imposed upon structure 1.3.1.1.3.1.1 would be so severe that it can be safely excluded from further consideration.

TABLE 17

| | | | | | | | Bond | | | Approx. | |
|---|---|---|---|---|---|---|---|---|---|---|---|
| | | Residues | | | Scars | | Cleavage | Theoretical | Observed | Observed | Intensity |
| Spectrum | Structure | H | N | n | (ene) | (oh) | Costs | m/z | m/z | Intensity | Sum |
| 1384.5 | 1.3.1.1.2.1.1 | | 1 | | 1 | | [0] | 282.13 | OOR | OOR | 109.20 |
| 1384.5 | 1.3.1.1.2.1.1 | 3 | 2 | | 1 | 1 | [0] | 1125.54 | 1125.45 | 100.00 | |
| 1384.5 | 1.3.1.1.2.1.1 | 1 | 1 | | 1 | | [1] | 486.23 | 486.18 | 0.12 | |
| 1384.5 | 1.3.1.1.2.1.1 | 1 | 1 | | | 1 | [1] | 504.24 | 504.27 | 0.09 | |
| 1384.5 | 1.3.1.1.2.1.1 | 2 | 2 | | 1 | 1 | [1] | 921.44 | 921.45 | 5.70 | |
| 1384.5 | 1 3.1 1 2 1.1 | 3 | 2 | | 1 | | [1] | 1139.56 | 1139.45 | 1.30 | |
| 1384.5 | 1.3.1.1.2.1.1 | 3 | 2 | | | 1 | [1] | 1157.57 | 1157.45 | 2.00 | |
| 1384.5 | 1.3.1.1.2.1.1 | | 1 | | 1 | 1 | | 268.12 | OOR | OOR | |
| 1384.5 | 1.3.1.1.3.1.1 | | 1 | | 1 | | [0] | 282.13 | OOR | OOR | 105.96 |
| 1384.5 | 1.3.1.1.3.1.1 | 3 | 2 | | 1 | 1 | [0] | 1125.54 | 1125.45 | 100.00 | |
| 1384.5 | 1.3.1.1.3.1.1 | 1 | 1 | | 1 | | [1] | 486.23 | 486.18 | 0.12 | |
| 1384.5 | 1.3.1.1.3.1.1 | 1 | 1 | | | 1 | [1] | 504.24 | 504.27 | 0.09 | |
| 1384.5 | 1.3.1.1.3.1.1 | 2 | 2 | | 1 | 1 | [1] | 921.44 | 921.45 | 5.70 | |
| 1384.5 | 1.3.1.1.3.1.1 | 2 | 2 | | 1 | | [1] | 935.46 | 935.55 | 0.02 | |
| 1384.5 | 1.3.1.1.3.1.1 | 2 | 2 | | | 1 | [1] | 953.47 | X | X | |
| 1384.5 | 1.3.1.1.3.1.1 | 1 | 1 | | 1 | 1 | [1] | 472.22 | 472.27 | 0.03 | |
| 1384.5 | 1.3.1.1.3.1.1 | 2 | 3 | | 1 | | [0] | 1180.59 | 1180.55 | 0.01 | |
| 1384.5 | 1.3.1.1.3.1.1 | 1 | | | 1 | 1 | [0] | 227.09 | OOR | OOR | |

### Simulate m/z 1677.87/H₃N₃n

Grow structures 1.3.1.1.2.1.1 and 1.3.1.1.3.1.1 to reach the target composition (Scheme 26).
This means adding a reducing-end n residue to occupy an (ene) scar.
The new n is marked with a prime.

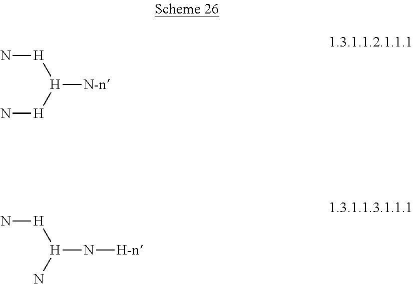

Predict fragments for both structures (Scheme 27).

### Scheme 27

1.3.1.1.2.1.1.1 N-(ene), H₃N₂n-(oh) [0]
   HN-(ene), HN-(oh), H₂N₂n-(oh) [1]
   H₃N₂-(ene), H₃N₂-(oh), Nn-(oh) [1]
   H₃N₃-(ene), n-(oh) [0]
1.3.1.1.3.1.1.1 N-(ene), H₃N₂n-(oh) [0]
   HN-(ene), HN-(oh), H₂N₂n-(oh) [1]
   H₂N₂-(ene), H₂N₂-(oh), HNn-(oh) [1]
   H₂N₃-(ene), Hn-(oh) [0]
   H₃N₃-(ene), H₃N₃-(oh), n-(oh) [1]
Score all structures (Table 18).
   We see that structure 1.3.1.1.2.1.1.1 has a higher intensity sum than 1.3.1.1.3.1.1.1, whose final score will be lowered further as the indicated penalties are applied
   The final highest scoring structure is 1.3.1.1.2.1.1.1 (see Scheme 26)
   This matches reported structure “C” on page 3835 of (Ashline 2007)
   Notice again how penalties to candidate 1.3.1.1.3.1.1.1 mark it as clearly inferior to candidate 1.3.1.1.2.1.1.1, despite the relatively close Intensity Sums.

TABLE 18

| | | | | | | | Bond | | | Approx. | |
|---|---|---|---|---|---|---|---|---|---|---|---|
| | | Residues | | | Scars | | Cleavage | Theoretical | Observed | Observed | Intensity |
| Spectrum | Structure | H | N | n | (ene) | (oh) | Costs | m/z | m/z | Intensity | Sum |
| 1677.8 | 1.3.1.1.2.1.1.1 | | 1 | | 1 | | [0] | 282.13 | OOR | OOR | 174.56 |
| 1677.8 | 1.3.1.1.2.1.1.1 | 3 | 2 | 1 | | 1 | [0] | 1418.72 | 1418.64 | 68.00 | |
| 1677.8 | 1.3.1.1.2.1.1.1 | 1 | 1 | | 1 | | [1] | 486.23 | 486.18 | 0.22 | |
| 1677.8 | 1.3.1.1.2.1.1.1 | 1 | 1 | | | 1 | [1] | 504.24 | 504.27 | 0.03 | |
| 1677.8 | 1.3.1.1.2.1.1.1 | 2 | 2 | 1 | | 1 | [1] | 1214.63 | 1214.55 | 3.00 | |
| 1677.8 | 1.3.1.1.2.1.1.1 | 3 | 2 | | 1 | | [1] | 1139.56 | 1139.45 | 0.80 | |
| 1677.8 | 1.3.1.1.2.1.1.1 | 3 | 2 | | | 1 | [1] | 1157.57 | 1157.45 | 2.50 | |
| 1677.8 | 1.3.1.1.2.1.1.1 | | 1 | 1 | | | [1] | 575.32 | 575.45 | 0.01 | |
| 1677.8 | 1.3.1.1.2.1.1.1 | 3 | 3 | | 1 | | [0] | 1384.68 | 1384.55 | 100.00 | |
| 1677.8 | 1.3.1.1.2.1.1.1 | | | 1 | | 1 | [0] | 316.17 | OOR | OOR | |
| 1677.8 | 1.3.1.1.3.1.1.1 | | 1 | | 1 | | [0] | 282.13 | OOR | OOR | 172.30 |
| 1677.8 | 1.3.1.1.3.1.1.1 | 3 | 2 | 1 | | 1 | [0] | 1418.72 | 1418.64 | 68.00 | |
| 1677.8 | 1.3.1.1.3.1.1.1 | 1 | 1 | | 1 | | [1] | 486.23 | 486.18 | 0.22 | |
| 1677.8 | 1.3.1.1.3.1.1.1 | 1 | 1 | | | 1 | [1] | 504.24 | 504.27 | 0.03 | |
| 1677.8 | 1.3.1.1.3.1.1.1 | 2 | 2 | 1 | | 1 | [1] | 1214.63 | 1214.55 | 3.00 | |
| 1677.8 | 1.3.1.1.3.1.1.1 | 2 | 2 | | 1 | | [1] | 935.46 | 935.36 | 0.03 | |
| 1677.8 | 1.3.1.1.3.1.1.1 | 2 | 2 | | | 1 | [1] | 953.47 | X | X | |
| 1677.8 | 1.3.1.1.3.1.1.1 | 1 | 1 | 1 | | 1 | [1] | 765.40 | 765.27 | 0.02 | |
| 1677.8 | 1.3.1.1.3.1.1.1 | 2 | 3 | | 1 | | [0] | 1180.59 | 1180.27 | 0.00 | |
| 1677.8 | 1.3.1.1.3.1.1.1 | 1 | | 1 | | 1 | [0] | 520.27 | X | X | |
| 1677.8 | 1.3.1.1.3.1.1.1 | 3 | 3 | | 1 | | [1] | 1384.68 | 1384.55 | 100.00 | |
| 1677.8 | 1.3.1.1.3.1.1.1 | 3 | 3 | | | 1 | [1] | 1402.69 | 1402.55 | 1.00 | |
| 1677.8 | 1.3.1.1.3.1.1.1 | | | 1 | | 1 | [1] | 316.17 | OOR | OOR | |

Next we will apply down-tree processing to further illustrate the superiority of 1.3.1.1.2.1.1.1. Down-tree processing serves to separate closely-related candidates by exploring additional product spectra in the MSⁿ tree. As such, we needed more than just a single structure to demonstrate down-tree processing.

### Down-Tree Processing (m/z 1418.5)

Down-tree processing can be applied before selecting the best candidate structure. In this example, we apply spectrum 1677.8_{—}1418.5 to both structures
The composition for m/z 1418.5 is H₃N₂n-(oh) and is arrived at by the loss of a terminal N from the full glycan.
Each remaining candidate can lose one of two terminal N residues, yielding the candidate substructures in Scheme 28.

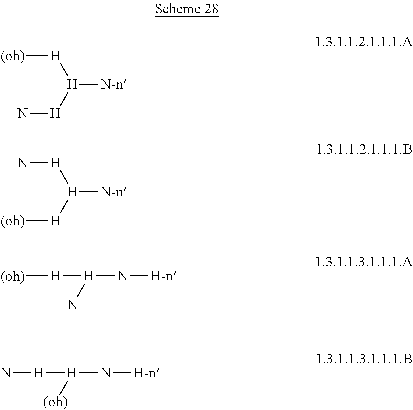

Eliminate 1.3.1.1.2.1.1.1.B as a duplicate of 1.3.1.1.2.1.1.1.A
   Both candidate structures could lose a terminal N from one of two locations, hence the A and B candidates for each. However, the A and B candidates from 1.3.1.1.2.1.1.1 are identical, and one can be safely eliminated.
Predict fragments (Scheme 29).

### Scheme 29

1.3.1.1.2.1.1.1.A N-(ene), H₃Nn-(oh)₂ [0]
   HN-(ene), HN-(oh), H₂Nn-(oh)₂ [1]
   H-(ene)(oh), H-(oh)₂, H₂N₂n-(oh) [1]
   H₃N-(ene)(oh), H₃N-(oh)₂, Nn-(oh) [1]
   H₃N₂-(ene)(oh), n-(oh) [0]
1.3.1.1.3.1.1.1.A H-(ene)(oh), H-(oh)₂, H₂N₂n-(oh) [1]
   N-(ene), H₃Nn-(oh)₂ [0]
   H₂N-(ene)(oh), H₂N-(oh)₂, HNn-(oh) [1]
   H₂N₂-(ene), Hn-(oh) [0]
   H₃N₂-(ene)(oh), H₃N₂-(oh)₂, n-(oh) [1]
1.3.1.1.3.1.1.1.B N-(ene), H₃Nn-(oh)₂ [0]
   HN-(ene), HN-(oh), H₂Nn-(oh)₂ [1]
   H₂N-(ene)(oh), H₂N-(oh)₂, HNn-(oh) [1]
   H₂N₂-(ene)(oh), Hn-(oh) [0]
   H₃N₂-(ene)(oh), H₃N₂-(oh)₂, n-(oh) [1]
      The A and B candidates from 1.3.1.1.3.1.1.1 are different and must be considered separately. Their generated ions could be pooled and processed together, but are shown separated here for clarity.
      Score all substructures (see Table 19)
         1.3.1.1.2.1.1.1.A has the highest intensity score, lending more support to 1.3.1.1.2.1.1.1
         Also, both 1.3.1.1.3.1.1.1.A and 1.3.1.1.3.1.1.1.B have fragments that are expected to be abundant but which are not (e.g., fragments m/z 935 and 520). The resulting penalties would lower the score of their precursor structure 1.3.1.1.3.1.1.1. This again serves to illustrate the inferiority of structure 1.3.1.1.3.1.1.1 versus 1.3.1.1.2.1.1.1.

TABLE 19

| | | | | | | | Bond | | | Approx. | |
|---|---|---|---|---|---|---|---|---|---|---|---|
| | | Residues | | | Scars | | Cleavage | Theoretical | Observed | Observed | Intensity |
| Spectrum | Structure | H | N | n | (ene) | (oh) | Costs | m/z | m/z | Intensity | Sum |
| 1418.5 | 1.3.1.1.2.1.1.1.A | | 1 | | 1 | | [0] | 282.13 | OOR | OOR | 127.14 |
| 1418.5 | 1.3.1.1.2.1.1.1.A | 3 | 1 | 1 | | 2 | [0] | 1159.58 | 1159.55 | 21.00 | |
| 1418.5 | 1.3.1.1.2.1.1.1.A | 1 | 1 | | 1 | | [1] | 486.23 | 486.18 | 0.11 | |
| 1418.5 | 1.3.1.1.2.1.1.1.A | 1 | 1 | | | 1 | [1] | 504.24 | 504.18 | 0.03 | |
| 1418.5 | 1.3.1.1.2.1.1.1.A | 2 | 2 | 1 | | 2 | [1] | 1200.61 | 1200.55 | 0.34 | |
| 1418.5 | 1.3.1.1.2.1.1.1.A | 1 | | | 1 | 1 | [1] | 227.09 | OOR | OOR | |
| 1418.5 | 1.3.1.1.2.1.1.1.A | 1 | | | | 2 | [1] | 245.10 | OOR | OOR | |
| 1418.5 | 1.3.1.1.2.1.1.1.A | 2 | 2 | 1 | | 1 | [1] | 1214.63 | 1214.64 | 2.60 | |
| 1418.5 | 1.3.1.1.2.1.1.1.A | 3 | 1 | | 1 | 1 | [1] | 880.41 | 880.45 | 0.85 | |
| 1418.5 | 1.3.1.1.2.1.1.1.A | 3 | 1 | | | 2 | [1] | 898.42 | 898.45 | 2.10 | |
| 1418.5 | 1.3.1.1.2.1.1.1.A | | 1 | 1 | | 1 | [1] | 561.30 | 561.27 | 0.11 | |
| 1418.5 | 1.3.1.1.2.1.1.1.A | 3 | 2 | | 1 | 1 | [0] | 1125.54 | 1125.45 | 100.00 | |
| 1418.5 | 1.3.1.1.2.1.1.1.A | | | 1 | | 1 | [0] | 316.17 | OOR | OOR | |
| 1418.5 | 1.3.1.1.3.1.1.1.A | 1 | | | 1 | 1 | [1] | 227.09 | OOR | OOR | 124.56 |
| 1418.5 | 1.3.1.1.3.1.1.1.A | 1 | | | | 2 | [1] | 245.10 | OOR | OOR | |
| 1418.5 | 1.3.1.1.3.1.1.1.A | 2 | 2 | 1 | | 1 | [1] | 1214.63 | 1214.64 | 2.60 | |
| 1418.5 | 1.3.1.1.3.1.1.1.A | | 1 | | 1 | | [0] | 282.13 | OOR | OOR | |
| 1418.5 | 1.3.1.1.3.1.1.1.A | 3 | 1 | 1 | | 2 | [0] | 1159.58 | 1159.55 | 21.00 | |
| 1418.5 | 1.3.1.1.3.1.1.1.A | 2 | 1 | | 1 | 1 | [1] | 676.31 | 676.18 | 0.14 | |
| 1418.5 | 1.3.1.1.3.1.1.1.A | 2 | 1 | | | 2 | [1] | 694.32 | 694.36 | 0.08 | |
| 1418.5 | 1.3.1.1.3.1.1.1.A | 1 | 1 | 1 | | 1 | [1] | 765.40 | 765.45 | 0.01 | |
| 1418.5 | 1.3.1.1.3.1.1.1.A | 2 | 2 | | 1 | | [0] | 935.46 | 935.27 | 0.02 | |
| 1418.5 | 1.3.1.1.3.1.1.1.A | 1 | | 1 | | 1 | [0] | 520.27 | 520.27 | 0.02 | |
| 1418.5 | 1.3.1.1.3.1.1.1.A | 3 | 2 | | 1 | 1 | [1] | 1125.54 | 1125.45 | 100.00 | |
| 1418.5 | 1.3.1.1.3.1.1.1.A | 3 | 2 | | | 2 | [1] | 1143.55 | 1143.64 | 0.70 | |
| 1418.5 | 1.3.1.1.3.1.1.1.A | | | 1 | | 1 | [1] | 316.17 | OOR | OOR | |
| 1418.5 | 1.3.1.1.3.1.1.1.B | 1 | | | 1 | | [0] | 241.10 | OOR | OOR | 125.18 |
| 1418.5 | 1.3.1.1.3.1.1.1.B | 3 | 1 | 1 | | 2 | [0] | 1159.58 | 1159.55 | 21.00 | |
| 1418.5 | 1.3.1.1.3.1.1.1.B | 1 | 1 | | 1 | | [1] | 486.23 | 486.18 | 0.11 | |
| 1418.5 | 1.3.1.1.3.1.1.1.B | 1 | 1 | | | 1 | [1] | 504.24 | 504.18 | 0.03 | |
| 1418.5 | 1.3.1.1.3.1.1.1.B | 2 | 1 | 1 | | 2 | [1] | 955.48 | 955.45 | 1.40 | |
| 1418.5 | 1.3.1.1.3.1.1.1.B | 2 | 1 | | 1 | 1 | [1] | 676.31 | 676.18 | 0.14 | |
| 1418.5 | 1.3.1.1.3.1.1.1.B | 2 | 1 | | | 2 | [1] | 694.32 | 694.36 | 0.08 | |
| 1418.5 | 1.3.1.1.3.1.1.1.B | 1 | 1 | 1 | | 1 | [1] | 765.40 | 765.45 | 0.01 | |
| 1418.5 | 1.3.1.1.3.1.1.1.B | 2 | 2 | | 1 | 1 | [0] | 921.44 | 921.45 | 1.70 | |
| 1418.5 | 1.3.1.1.3.1.1.1.B | 1 | | 1 | | 1 | [0] | 520.27 | 520.27 | 0.02 | |
| 1418.5 | 1.3.1.1.3.1.1.1.B | 3 | 2 | | 1 | 1 | [1] | 1125.54 | 1125.45 | 100.00 | |
| 1418.5 | 1.3.1.1.3.1.1.1.B | 3 | 2 | | | 2 | [1] | 1143.55 | 1143.64 | 0.70 | |
| 1418.5 | 1.3.1.1.3.1.1.1.B | | | 1 | | 1 | [1] | 316.17 | OOR | OOR | |

gtSequenceAll Summary

The combination of up-tree and down-tree processing declares 1.3.1.1.2.1.1.1 as the structure that best fits the examined spectra. This structure as been reported as structure “C” in Ashline 2007, page 3835.

Additional Features of gtSequenceAll

Note that this assembly proceeded without the assumption that the target glycan contained the five-residue N-linked core, but rather correctly inferred the core directly from the data. Prior to the methods of the invention described herein, no existing de novo tool has been capable of such a feat for a glycan of this size. Note also that the algorithm found the expected structure without generating a large number of candidate structures. This feature can be advantageous when, for example, computational resources are limited. Other features of the method may be modified and such modifications can be envisioned and executed by those skilled in the art. Exemplary, non-limiting modifications are described below.

Thresholds for “Missing” Ions

Users can set a relative intensity threshold for considering an ion to be absent. In this presentation, absent means a relative intensity of 0%, but 0.1% can also be used in some cases. The threshold can also be varied based on the structure size and number of predicted low-cost bonds, which absorb collisional energy. That is, if many low-cost bonds are present, it becomes more likely that high-cost bonds will not be ruptured in detectable quantities. Alternatively, the threshold can be raised for fragments predicted to be of higher abundance.

Simulated fragmentation
Combining multiple fragmentations, especially of zero- or low-cost bonds, to predict generated fragments.
Pairing the (ene) or the (oh) fragmentations from an H residue and requiring only one be present, instead of both.

Scoring

The method can use fragments that are unique to exactly one candidate and cause the score to accentuate the difference between candidates. Alternatively, the unique fragments could be weighted more heavily. The relative abundance of isomers can also be used to weight the scoring method. If isomer X is known to be much more abundant that isomer Y, then X's major peaks should be more abundant than Y's. In another modification, the penalties applied can be reduced when the corresponding experimental spectrum is of poor quality. On a Thermo LTQ, for example, a low normalization level (NL) may mean that ions were so sparse that minor fragments will not be observed. This can be compensated for by accumulating data for a longer period and data averaging. In this case penalties would be reduced for small values of the product NL*(acquisition time). Penalties can also be reduced if the “missing” fragment could only be generated by applying multiple cleavages to the precursor structure.

### Example 4

### Interactive Spectrum Labeling

To better understand Interactive Spectrum Labeling (or Annotating), consider a simplified MSⁿ spectrumtree for IgG glycan m/z 1677.8 as described in Table 20. However, the process extends to the entire MSⁿ spectrum tree. Also for clarity, this example only considers fragment compositions that can arise from the rupture of glycosidic bonds. Again the process extends to other types of cleavages, such as cross-ring fragments and the loss of N-acetyl groups. Lastly, this example focuses on permethylated glycans, but this is not an inherent limitation of the procedure.

For this example and for illustrative purposes, we assume that only three spectra have been collected: 1677.8, 1677.81418.7, and 1677.81418.7900.4. Further we assume that each spectrum contains only two m/z peaks.

TABLE 20

| Spectrum or Peak | Possible Compositions |
|---|---|
| Spectrum 1677.8 | H₃N₃n |
| | H₂N₄h |
| Peak 1384.6 | H₃N₃-(ene) |
| Peak 1418.7 | H₃N₂n-(oh) |
| | H₂N₃h-(oh) |
| Spectrum 1677.8_1418.7 | H₃N₂n-(oh) |
| | H₂N₃h-(oh) |
| Peak 900.4 | H₃n-(oh)₃ |
| | H₂Nh-(oh)₃ |
| Peak 1125.4 | H₃N₂-(ene)(oh) |
| Spectrum 1677.8_1418.7_900.4 | H₃n-(oh)₃ |
| | H₂Nh-(oh)₃ |
| Peak 316.4 | n-(oh) |
| Peak 696.4 | H₂n-(oh)₃ |
| | HNh-(oh)₃ |

For each spectrum's terminal ion, we see that there are there are two possible compositions: m/z 1677.8 can be H₃N₃n or H₂N₄h, m/z 1418.7 (as isolated from 1677.8) can be H₃N₂n-(oh) or H₂N₃h-(oh), and m/z 900.4 (as isolated from 1677.8_{—}1418.7) can be H₃n-(oh)₃ or H₂Nh-(oh)₃. Most of the ions on these spectra also have two interpretations, as shown in the table.

The underlying problem is that Nh has the same mass as Hn—that is, reducing a hexose changes its mass by the same amount as reducing a HexNAc. This leads to the composition ambiguities shown above, where any fragment composition that includes Nh must also have the equivalent composition with Hn substituted instead. This confusion would be greatly magnified over a larger MSⁿ tree where each spectrum would have many m/z peaks.

Interactive spectrum annotation reduces this confusion by allowing an external agent (an analyst or algorithm) to eliminate possible compositions at any point in the MSⁿ tree. Removing these compositions will reduce the number of composition possibilities at all subsequent product spectra and their contained peaks.

In this example, we assume that the analyst (or external algorithm) has knowledge that the glycan under investigation does in fact have a reducing-end HexNAc (n) and not a reducing-end hexose (h). The analyst can transfer this knowledge to the system by eliminating H₂N₄h as a possible composition for spectrum 1677.8. See Table 21 and notice the highlighted (eliminated) composition.

TABLE 21

| Spectrum or Peak | Possible Compositions |
|---|---|
| Spectrum 1677.8 | H₃N₃n |
| Peak 1384.6 | H₃N₃-(ene) |
| Peak 1418.7 | H₃N₂n-(oh) |
| | H₂N₃h-(oh) |
| Spectrum 1677.8_1418.7 | H₃N₂n-(oh) |
| | H₂N₃h-(oh) |
| Peak 900.4 | H₃n-(oh)₃ |
| | H₂Nh-(oh)₃ |
| Peak 1125.4 | H₃N₂-(ene)(oh) |
| Spectrum 1677.8_1418.7_900.4 | H₃n-(oh)₃ |
| | H₂Nh-(oh)₃ |
| Peak 316.4 | n-(oh) |
| Peak 696.4 | H₂n-(oh)₃ |
| | HNh-(oh)₃ |

Now the possible compositions of all product spectra derived directly or indirectly from spectrum 1677.8 can be updated. Because of the precursor/product relationship guaranteed by MSⁿ, the only compositions allowed for product spectra are those that are a subset of the composition available at spectrum 1677.8, namely H₃N₃n. Propagating this change eliminates a composition possibility from spectrum 1677.8_{—}1418.7, which in turn eliminates a composition possibility from spectrum 1677.8_{—}1418.7_{—}900.4. See Table 22.

TABLE 22

| Spectrum or Peak | Possible Compositions |
|---|---|
| Spectrum 1677.8 | H₃N₃n |
| Peak 1384.6 | H₃N₃-(ene) |
| Peak 1418.7 | H₃N₂n-(oh) |
| | H₂N₃h-(oh) |
| Spectrum 1677.8_1418.7 | H₃N₂n-(oh) |
| Peak 900.4 | H₃n-(oh)₃ |
| | H₂Nh-(oh)₃ |
| Peak 1125.4 | H₃N₂-(ene)(oh) |
| Spectrum 1677.8_1418.7_900.4 | H₃n-(oh)₃ |
| Peak 316.4 | n-(oh) |
| Peak 696.4 | H₂n-(oh)₃ |
| | HNh-(oh)₃ |

Now that the spectra have had their composition sets adjusted, we apply similar logic to each contained peak. If a putative peak composition cannot have been generated from any of its spectrum's remaining compositions, the peak composition is excluded.

For example, spectrum 1677.8_{—}1418.7_{—}900.4 contains the peak 696.4, which currently has two possible compositions, H₂n-(oh)₃ and HNh-(oh)₃. However, the spectrum no longer contains a reduced hexose (h) in any of its compositions, and so we eliminate HNh-(oh)₃ as a possible composition for this peak. See Table 23 to see the composition changes to three peaks across the three spectra.

TABLE 23

| Spectrum or Peak | Possible Compositions |
|---|---|
| Spectrum 1677.8 | H₃N₃n |
| Peak 1384.6 | H₃N₃-(ene) |
| Peak 1418.7 | H₃N₂n-(oh) |
| Spectrum 1677.8_1418.7 | H₃N₂n-(oh) |
| Peak 900.4 | H₃n-(oh)₃ |
| Peak 1125.4 | H₃N₂-(ene)(oh) |
| Spectrum 1677.8_1418.7_900.4 | H₃n-(oh)₃ |
| Peak 316.4 | n-(oh) |
| Peak 696.4 | H₂n-(oh)₃ |

For clarity, Table 24 shows the final composition assignments for all spectra and peaks after the propagation has been completed. Notice the reduction in complexity as compared to the starting point of the analysis.

TABLE 24

| Spectrum or Peak | Possible Compositions |
|---|---|
| Spectrum 1677.8 | H₃N₃n |
| Peak 1384.6 | H₃N₃-(ene) |
| Peak 1418.7 | H₃N₂n-(oh) |
| Spectrum 1677.8_1418.7 | H₃N₂n-(oh) |
| Peak 900.4 | H₃n-(oh)₃ |
| Peak 1125.4 | H₃N₂-(ene)(oh) |
| Spectrum 1677.8_1418.7_900.4 | H₃n-(oh)₃ |
| Peak 316.4 | n-(oh) |
| Peak 696.4 | H₂n-(oh)₃ |

Beyond the application of precursor/product constraints as shown above, many other constraints can be applied to reduce the number of composition possibilities for both the examined spectra and their contained peaks. These constraints include, but are not limited to:
1) Requiring that the five-residue N-linked core be present
2) Requiring that the glycan be native, reduced, derivatized, or otherwise modified
3) Requiring that the top-level ion represent a glycan with (or without) cleavage scars
4) Excluding ions below some relative or absolute intensity threshold

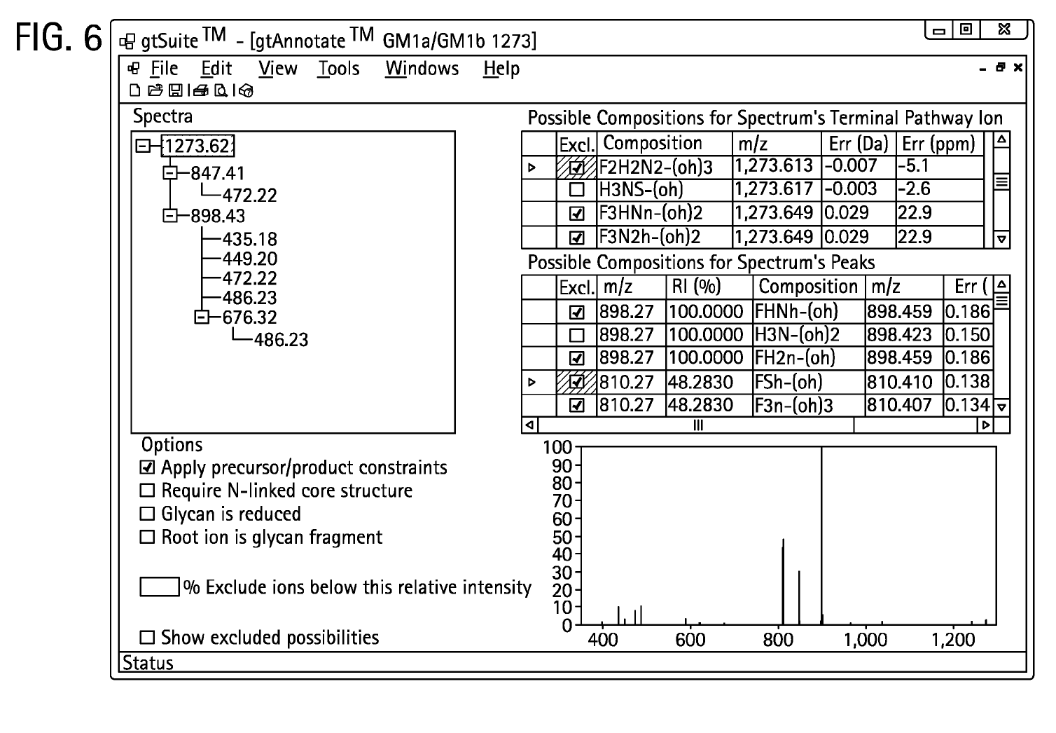

FIG. 6 illustrates the application of Interactive Spectrum Annotation to the data set for GM1a/GM1b using a computer interface. In this figure, the top-left panel represents the MSⁿ spectrum tree, the bottom-left panel shows a few of the constraints that can be applied. On the right side, the top grid represents the possible compositions of ion m/z 1273.62. The grayed-out entries have been eliminated either by direct action from the user or by the application of direct and indirect constraints by the tool. Only one composition remains: H₃NS-(oh). The lower grid shows possible compositions for the peaks of this spectrum, where the spectrum itself is the graph at bottom right.

Note that two composition possibilities for ion m/z 898.27 have been eliminated: FHNh-(oh) and FH₂n-(oh). Because the user has selected the constraint labeled “Apply precursor/product constraints”, these two compositions are eliminated because the sole remaining composition for m/z 1273.62—H₃NS-(oh)—could generate neither FHNh-(oh) nor FH₂n-(oh). Selecting product spectra under m/z 1273.62 would reflect additional eliminations caused by the application of product/precursor constraints, or any other constraints selected or provided by the user.

While the invention has been described in connection with specific embodiments thereof, it will be understood that it is capable of further modifications and this application is intended to cover any variations, uses, or adaptations of the invention following, in general, the principles of the invention and including such departures from the present disclosure that come within known or customary practice within the art to which the invention pertains and may be applied to the essential features hereinbefore set forth, and follows in the scope of the claims.

All publications, patents, and patent applications mentioned in this specification, including U.S. Provisional Application Nos. 61/057,596 and 61/134,440, are herein incorporated by reference to the same extent as if each independent publication or patent application was specifically and individually indicated to be incorporated by reference.

### REFERENCES

1. Ada, G.; Isaacs, D. Clin Microbiol Infect. “Carbohydrate-protein conjugate vaccines”, 2003, 9 (2), 79-85.
2. Alper, J. In Science, “Turning Sweet on Cancer”, 2003; Vol. 301.
3. Aoki, K. F.; Yamaguchi, A.; Ueda, N.; Akutsu, T.; Mamitsuka, H.; Goto, S.; Kanehisa, M. Nucleic Acids Research “KCaM (KEGG Carbohydrate Matcher): a software tool for analyzing the structures of carbohydrate sugar chains”, 2004, 32 (Web Server Issue), W267-W272.
4. Apweiler, R.; Hermjakob, H.; Sharon, N. Biochim Biophys Acta. “On the frequency of protein glycosylation, as deduced from analysis of the SWISS-PROT database”, 1999, 1473 (1), 4-8.
5. Ashline, D.; Singh, S.; Hanneman, A.; Reinhold, V. Anal. Chem. “Congruent Strategies for Carbohydrate Sequencing: 1. Mining Structural Details by MS”, 2005, 77 (19), 6250-6262.
6. Ashline, D. J.; Lapadula, A. J.; Liu, Y. H.; Lin, M.; Grace, M.; Pramanik, B.; Reinhold, V. N. Anal Chem “Carbohydrate structural isomers analyzed by sequential mass spectrometry”, 2007, 79 (10), 3830-3842.
7. Ashline, D. J.; Lapadula, A. J.; Reinhold, V., 54th ASMS Conference on Mass Spectrometry, “Analysis of Isobaric Oligosaccharide Mixtures by Sequential Mass Spectrometry (Poster ThP 302)”, Seattle, Wash., May 28-Jun. 1, 2006.
8. Ashline, D. J.; Lapadula, A. J.; Reinhold, V. N. “Isomeric N-linked Oligosaccharides in IgG Containing Reducing-end Hexose and Reducing-end Fucose Determined by Sequential Mass Spectrometry”, 2007 (in preparation).
9. Brooks, S. A.; Dwek, M. V.; Schumacher, U. Functional and Molecular Glycobiology; BIOS Scientific Publishers Limited: Oxford, UK, 2002.
10. Brown, W. H. Introduction to Organic Chemistry; Saunders College Publishing, 1997.
11. Butler, M.; Quelhas, D.; Critchley, A. J.; Carchon, H.; Hebestreit, H. F.; Hibbert, R. G.; Vilarinho, L.; Teles, E.; Matthijs, G.; Schollen, E.; Argibay, P.; Harvey, D. J.; Dwek, R. A.; Jaeken, J.; Rudd, P. M. Glycobiology “Detailed glycan analysis of serum glycoproteins of patients with congenital disorders of glycosylation indicates the specific defective glycan processing step and provides an insight into pathogenesis”, 2003, 13 (9), 601-622.
12. Butters, T. D.; Dwek, R. A.; Platt, F. M. Adv Exp Med Biol. “New therapeutics for the treatment of glycosphingolipid lysosomal storage diseases”, 2003, 535, 219-226.
13. Campbell, M. K.; Farrell, S. O. Biochemistry, 4 ed.; Thomson Brooks/Cole, 2003.
14. Cancilla, M. T.; Penn, S. G.; Lebrilla, C. B. Anal. Chem. “Alkaline Degradation of Oligosaccharides Coupled with Matrix-Assisted Laser Desorption/Ionization Fourier Transform Mass Spectrometry: A Method for Sequencing Oligosaccharides”, 1998, 70, 663-672.
15. Ciucanu, I.; Kerek, F. Carbohydr. Res. “A simple and rapid method for the permethylation of carbohydrates”, 1984, 131, 209-217.
16. Cooper, C. A.; Gasteiger, E.; Packer, N. H. Proteomics “GlycoMod—a software tool for determining glycosylation compositions from mass spectrometric data”, 2001, 1, 340-349.
17. Cooper, C. A.; Joshi, H. J.; Harrison, M. J.; Wilkins, M. R.; Packer, N. H. Nucleic Acids Research “GlycoSuiteDB: a curated relational database of glycoprotein glycan structures and their biological sources. 2003 update”, 2003, 31 (1), 511-513.
18. Domon, B.; Costello, C. E. Glycoconjugate J. “A Systematic Nomenclature for Carbohydrate Fragmentations in FABMS/MS of Glycoconjugates”, 1988, 5, 397-409.
19. Dove, A. In Nature Biotechnology, “The bittersweet promise of glycobiology”, 2001; Vol. 19, pp 913-917.
20. Dwek, R. A. Chem. Rev. “Glycobiology: Toward Understanding the Function of Sugars”, 1996, 96, 683-720.
21. Dwek, R. A.; Butters, T. D.; Platt, F. M.; Zitzmann, N. Nat Rev Drug Discov. “Targeting glycosylation as a therapeutic approach”, 2002, 1 (1), 65-75.
22. Dziadek, S.; Kunz, H. Chem Rec. “Synthesis of tumor-associated glycopeptide antigens for the development of tumor-selective vaccines”, 2004, 3 (6), 308-321.
23. Ethier, M.; Saba, J. A.; Ens, W.; Standing, K. G.; Perreault, H. Rapid Commun. in Mass Spectrom. “Automated Structure Assignment of Derivatized Complex N-linked Oligosaccharides from Tandem Mass Spectra”, 2002, 16, 1743-1754.
24. Ethier, M.; Saba, J. A.; Spearman, M.; Krokhin, O.; Butler, M.; Ens, W.; Standing, K. G.; Perreault, H. Rapid Commun. Mass Spectrom. “Application of the StrOligo Algorithm for the Automated Structure Assignment of Complex N-Linked Glycans from Glycoproteins Using Tandem Mass Spectrometry”, 2003, 17, 2713-2720.
25. Gabius, H.-J.; André, S.; Kaltner, H.; Siebert, H.-C. Biochim Biophys Acta. “The sugar code: functional lectinomics”, 2002, 1572, 165-177.
26. Gabius, H.-J.; Siebert, H.-C.; André, S.; Jimenez-Barbero, J.; Rudiger, H. ChemBioChem “Chemical Biology of the Sugar Code”, 2004, 5, 740-764.
27. Gaucher, S. P.; Cancilla, M. T.; Phillips, N. J.; Gibson, B. W.; Leary, J. A. Biochemistry “Mass spectral characterization of lipooligosaccharides from Haemophilus influenzae 2019”, 2000, 39 (40), 12406-12414.
28. Gaucher, S. P.; Morrow, J.; Leary, J. A. Anal. Chem. “STAT: A Saccharide Topology Analysis Tool Used in Combination with Tandem Mass Spectrometry”, 2000, 72, 2331-2336.
29. Geyer, H.; Geyer, R. Biochim Biophys Acta “Strategies for analysis of glycoprotein glycosylation”, 2006, 1764 (12), 1853-1869.
30. Goldberg, D.; Sutton-Smith, M.; Paulson, J.; Dell, A. Proteomics “Automatic annotation of matrix-assisted laser desorption/ionization N-glycan spectra.” 2005, 4, 865-875.
31. Hanneman, A.; Reinhold, V. Glycobiology “Abundant and Unusual N-Linked Glycans from the Eukaryote, C. elegans (Abstract 280)”, 2003, 13 (11), 899-900.
32. Hanneman, A.; Singh, S.; Zhang, H.; Reinhold, V., 51st ASMS Conference, “Unraveling Isobaric C. elegans Glycomers: Molecular Disassembly (MSⁿ) and Structural Continuity (Abstract TPB 031)”, Montreal, Quebec, Canada, Jun. 8-12, 2003.
33. Hanneman, A. J.; Reinhold, V., Joint Meeting of The Society for Glycobiology and The Japanese Society for Carbohydrate Research, “Structural Diversity of C. elegans Glycome (Abstract 252)”, Honolulu, Hi., Nov. 17-20, 2004.
34. Harvey, D. J. J Am Soc Mass Spectrom “Fragmentation of negative ions from carbohydrates: part 1. Use of nitrate and other anionic adducts for the production of negative ion electrospray spectra from N-linked carbohydrates”, 2005, 16 (5), 622-630.
35. Harvey, D. J. J Am Soc Mass Spectrom “Fragmentation of negative ions from carbohydrates: part 2. Fragmentation of high-mannose N-linked glycans”, 2005, 16 (5), 631-646.
36. Harvey, D. J. J Am Soc Mass Spectrom “Fragmentation of negative ions from carbohydrates: part 3. Fragmentation of hybrid and complex N-linked glycans”, 2005, 16 (5), 647-659.
37. Harvey, D. J. Mass Spectrom Rev. “Matrix-assisted laser desorption/ionization mass spectrometry of carbohydrates”, 1999, 18 (6), 349-450.
38. Harvey, D. J.; Royle, L.; Radcliffe, C. M.; Rudd, P. M.; Dwek, R. A. Anal Biochem “Structural and quantitative analysis of N-linked glycans by matrix-assisted laser desorption ionization and negative ion nanospray mass spectrometry”, 2008, 376 (1), 44-60.
39. Harvey, D. J.; Wing, D. R.; Mister, B.; Wilson, I. G. H. J. Am. Soc. for Mass Spec. “Composition of N-linked carbohydrates from ovalbumin and co-purified glycoproteins”, 2000, 11, 564-571.
40. Hedrick, J. L.; Nishihara, T. J Electron Microsc Tech. “Structure and function of the extracellular matrix of anuran eggs”, 1991, 17 (3), 319-335.
41. Hitchcock, A. M.; Yates, K. E.; Costello, C. E.; Zaia, J. Proteomics “Comparative glycomics of connective tissue glycosaminoglycans”, 2008, 8 (7), 1384-1397.
42. Hokke, C. H.; Deedler, A. M. Glycoconj J. “Schistosome glycoconjugates in host-parasite interplay”, 2001, 18 (8), 573-587.
43. Hooper, L. V.; Gordon, J. I. Glycobiology “Glycans as legislators of host-microbial interactions: spanning the spectrum from symbiosis to pathogenicity”, 2001, 11 (2), 1R-10R.
44. Huby, R. D.; Dearman, R. J.; Kimber, I. Toxicol Sci. “Why are some proteins allergens?” 2000, 55 (2), 235-246.
45. Ioffe, E.; Stanley, P. Proc Natl Acad Sci USA. “Mice lacking N-acetylglucosaminyltransferase I activity die at mid-gestation, revealing an essential role for complex or hybrid N-linked carbohydrates”, 1994, 91 (2), 728-732.
46. Jaeken, J.; Matthijs, G. Annual Review of Genomics and Human Genetics “Congenital disorders of glycosylation”, 2001, 2, 129-151.
47. Jeyakumar, M.; Butters, T. D.; Dwek, R. A.; Platt, F. M. Neuropathol Appl Neurobiol. “Glycosphingolipid lysosomal storage diseases: therapy and pathogenesis”, 2002, 28 (5), 343-357.
48. Joshi, H. J.; Harrison, M. J.; Schulz, B. L.; Cooper, C. A.; Packer, N. H.; Karlsson, N. G. Proteomics “Development of a mass fingerprinting tool for automated interpretation of oligosaccharide fragmentation data”, 2004, 4, 1650-1664.
49. Kannagi, R. Curr Opin Struct Biol “Regulatory roles of carbohydrate ligands for selectins in the homing of lymphocytes”, 2002, 12 (5), 599-608.
50. Khoo, K. H.; Dell, A. Adv Exp Med Biol. “Glycoconjugates from parasitic helminths: structure diversity and immunobiological implications”, 2001, 491, 185-205.
51. Koeller, K. M.; Wong, C.-H. Nature Biotechnology “Emerging Themes in Medicinal Glycoscience”, 2000, 18, 835-841.
52. König, S.; Leary, J. A. J. Am. Soc. for Mass Spec. “Evidence for linkage position determination in cobalt coordinated pentasaccharides using ion trap mass spectrometry”, 1998, 9 (11), 1125-1134.
53. Küster, B.; Naven, T. J.; Harvey, D. J. J Mass Spectrom. “Rapid approach for sequencing neutral oligosaccharides by exoglycosidase digestion and matrix-assisted laser desorption/ionization time-of-flight mass spectrometry”, 1996, 31 (10), 1131-1140.
54. Laine, R. A. Glycobiology “A calculation of all possible oligosaccharide isomers both branched and linear yields 1.05×10¹² structures for a reducing hexasaccharide: the Isomer Barrier to development of single-method saccharide sequencing or synthesis systems.” 1994, 4 (6), 759-767.
55. Lapadula, A. J. “GlySpy and the Oligosaccharide Subtree Constraint Algorithm (OSCAR): A Computational Approach to Sequencing Glycans”, Technical Report, Dept. of Comp. Sci., Univ. of New Hampshire 2004.
56. Lapadula, A. J. “GlySpy: A Software Suite for Assigning Glycan Topologies from Sequential Mass Spectral Data”, Dissertation, University of New Hampshire, Durham, 2007.
57. Lapadula, A. J.; Ashline, D. J.; Zhang, H.; Reinhold, V., 54th ASMS Conference on Mass Spectrometry, “Automated Detection of Glycan Isobars with the Bioinformatics Tool GlySpy (Poster ThP 295)”, Seattle, Wash., May 28-Jun. 1, 2006.
58. Lapadula, A. J.; Hatcher, P. J.; Hanneman, A. J.; Ashline, D. J.; Zhang, H.; Reinhold, V. N. Anal. Chem. “Congruent Strategies for Carbohydrate Sequencing. 3. OSCAR: An Algorithm for Assigning Oligosaccharide Topology from MSⁿ Data”, 2005, 77 (19), 6271-6279.
59. Leavell, M. D.; Leary, J. A.; Yamasaki, R. J. Am. Soc. for Mass Spec. “Mass Spectrometric Strategy for the Characterization of Lipooligosaccharides from Neisseria gonorrhoeae 302 Using FTICR”, 2002, 13, 571-576.
60. Lo-Man, R.; Vichier-Guerre, S.; Perraut, R.; Deriaud, E.; Huteau, V.; BenMohamed, L.; Diop, O. M.; Livingston, P. O.; Bay, S.; Leclerc, C. Cancer Res. “A fully synthetic therapeutic vaccine candidate targeting carcinoma-associated Tn carbohydrate antigen induces tumor-specific antibodies in nonhuman primates”, 2004, 64 (14), 4987-4994.
61. Lowe, J. B.; Marth, J. D. Annual Rev. Biochem. “A genetic approach to mammalian glycan function”, 2001, 72, 643-691.
62. Maeder, T. In Scientific American, “Sweet Medicines”, 2002.
63. Marchal, I.; Golfier, G.; Dugas, O.; Majed, M. Biochemie “Bioinformatics in glycobiology”, 2003, 85, 75-81.
64. McLafferty, F. W. Interpretation of Mass Spectra, 2^{nd} ed.; W. A. Benjamin: Reading, Mass., 1973.
65. Mozingo, N. M.; Hedrick, J. L. Developmental Bio “Distribution of lectin binding sites in Xenopus laevis egg jelly”, 1999, 210 (2), 428-439.
66. Muhlecker, W.; Gulati, S.; McQuillen, D. P.; Ram, S.; Rice, P. A.; Reinhold, V. N. Glycobiology “An essential saccharide binding domain for the mAb 2C7 established for Neisseria gonorrhoeae LOS by ES-MS and MSⁿ.” 1999, 9 (2), 157-171.
67. Nomenclature Committee of the Consortium for Functional Glycomics “Symbol and Text Nomenclature for Representation of Glycan Structure”, 2004. http://glycomics.scripps.edu/CFGnomenclature.pdf
68. Nyame, A. K.; Kawar, Z. S.; Cummings, R. D. Arch Biochem Biophys “Antigenic glycans in parasitic infections: implications for vaccines and diagnostics”, 2004, 426 (2), 182-200.
69. Ono, M.; Hakomori, S. Glycoconjugate Journal “Glycosylation defining cancer cell motility and invasiveness”, 2004, 20, 71-78.
70. Parodi, A. J. Ann. Rev. Biochem. “Protein glucosylation and its role in protein folding”, 2000, 69, 69-93.
71. Platt, F. M.; Jeyakumar, M.; Andersson, U.; Heare, T.; Dwek, R. A.; Butters, T. D. Philos Trans R Soc Lond B Biol Sci. “Substrate reduction therapy in mouse models of the glycosphingolipidoses”, 2003, 358 (1433), 947-954.
72. Prien, J. M. “Uncovering Unique N-linked Glycan Structural Isomers in Cancer via MSn Disassembly”, Dissertation, University of New Hampshire, Durham, 2007.
73. Prien, J. M.; Huysentruyt, L. C.; Ashline, D. J.; Lapadula, A. J.; Seyfried, T. N.; Reinhold, V. N. Glycobiology “Differentiating N-linked Glycan Structural Isomers in Metastatic and Non-Metastatic Tumor Cells using Sequential Mass Spectrometry”, 2008.
74. Rademacher, T. W.; Parekh, R. B.; Dwek, R. A. Ann. Rev. Biochem. “Glycobiology”, 1988, 57, 785-838.
75. Reinhold, V.; Singh, S.; Zhang, H.; Hanneman, A., Joint Meeting of The Society for Glycobiology and The Japanese Society for Carbohydrate Research, “De novo MSⁿ Sequencing with Contiguous Glycan Segments (Abstract 490)”, Honolulu, Hi., Nov. 17-20, 2004.
76. Reinhold, V. N.; Lapadula, A. J.; Ashline, D. J.; Zhang, H. “Systems and Methods for Sequencing Carbohydrates”, U.S. patent application Ser. No. 11/899,395, International Patent Application No. PCT/US2007/019309, University of New Hampshire, USA, Sep. 4, 2007.
77. Reinhold, V. N.; Reinhold, B. B.; Chan, S. Meth. In Enzym. “Carbohydrate sequence analysis by electrospray ionization-mass spectrometry”, 1996, 271, 377-402.
78. Reinhold, V. N.; Reinhold, B. B.; Costello, C. E. Anal. Chem. “Carbohydrate Molecular Weight Profiling, Sequence, Linkage, and Branching Data: ES-MS and CID”, 1995, 67, 1772-1784.
79. Shan, B.; Ma, B.; Zhang, K.; Lajoie, G. J Bioinform Comput Biol “Complexities and algorithms for glycan sequencing using tandem mass spectrometry”, 2008, 6 (1), 77-91.
80. Sheeley, D. M.; Reinhold, V. N. Anal. Chem. “Structural characterization of carbohydrate sequence, linkage, and branching in a quadrupole ion trap mass spectrometer: Neutral oligosaccharides and N-Linked glycans”, 1998, 70, 3053-3059.
81. Sheridan, C. Nat Biotechnol “Commercial interest grows in glycan analysis”, 2007, 25 (2), 145-146.
82. Singh, S.; Reinhold, V. N., Proceedings of 8th Annual Conference of the Society for Glycobiology, “Glycan Disassembly by MSⁿ: Linkage, Branching and Monomer Identification (Abstract 80)”, San Diego, Calif., USA, Dec. 3-6, 2003.
83. Singh, S.; Reinhold, V. N.; Bennion, B.; Levery, S. B., Proceedings of 8th Annual Conference of the Society for Glycobiology, “Application of ion trap MSⁿ strategies to structure elucidation of diverse glycosylinositols derived from fungal glycosphingolipids (Abstract 5)”, San Diego, Calif., USA, Dec. 3-6, 2003.
84. Stanley, P.; Ioffe, E. FASEB J. “Glycosyltransferase mutants: key to new insights in glycobiology”, 1995, 9 (14), 1436-1444.
85. Stephan, M. M. In The Scientist, “Sugars Get an 'Ome of their Own”, 2004; Vol. 18.
86. Svennerholm, L. J. of Neurochemistry “Chromatographic separation of human brain gangliosides”, 1963, 10, 613-623.
87. Tang, H.; Mechref, Y.; Novotny, M. V. Bioinformatics “Automated interpretation of MS/MS spectra of oligosaccharides”, 2005, 21 (Suppl. 1), i431-i439.
88. Tseng, K.; Hedrick, J. L.; Lebrilla, C. B. Anal. Chem. “Catalog-library approach for the rapid and sensitive structural elucidation of oligosaccharides”, 1999, 71, 3747-3754.
89. Tseng, K.; Xie, Y.; Seeley, J.; Hedrick, J. L.; Lebrilla, C. B. Glycoconjugate J. “Profiling with structural elucidation of the neutral and anionic O-linked oligosaccharides in the egg jelly coat of Xenopus laevis by Fourier transform mass spectrometry”, 2001, 18, 309-320.
90. Turner, M. S.; McKolanis, J. R.; Ramanathan, R. K.; Whitcomb, D. C.; Finn, O. J. Cancer Chemother Biol Response Modif “Mucins in gastrointestinal cancers”, 2003, 21, 259-274.
91. Van den Steen, P.; Rudd, P. M.; Dwek, R. A.; Opdenakker, G. Crit Rev Biochem Mol Biol. “Concepts and principles of O-linked glycosylation”, 1998, 33 (3), 151-208.
92. Various In Science, “Carbohydrates and Glycobiology (Special Report)”, 2001; Vol. 291, pp 2337-2378.
93. Varki, A. Glycobiology “Biological roles of oligosaccharides: all of the theories are correct”, 1993, 3 (2), 97-130.
94. Varki, A.; Cummings, R.; Esko, J.; Freeze, H.; Hart, G.; Marth, J., Eds. Essentials of Glycobiology; Cold Spring Harbor Laboratory Press: New York, 1999.
95. Viseux, R.; de Hoffman, E.; Domon, B. Anal. Chem. “Structural Assignment of Permethylated Oligosaccharide Subunits Using Sequential Tandem Mass Spectrometry”, 1998, 70, 4951-4959.
96. von der Lieth, C.-W.; Lütteke, T.; Frank, M. Biochimica et Biophysica Acta “The role of informatics in glycobiology research with special emphasis on automatic interpretation of MS spectra”, 2006, 1760, 568-577.
97. Vosseller, K.; Wells, L.; Hart, G. W. Biochemie “Nucleocytoplasmic O-glycosylation: O-GlcNAc and functional proteomics”, 2001, 83 (7), 575-581.
98. Walsh, G. Nature Biotechnology “Biopharmaceutical benchmarks—2003”, 2003, 21, 865-870.
99. Weiskopf, A. S.; Vouros, P.; Harvey, D. J. Rapid Commun. in Mass Spectrom. “Characterization of Oligosaccharide Composition and Structure by Quadrupole Ion Trap Mass Spectrometry”, 1997, 11, 1493-1504.
100. Xie, Y.; Tseng, K.; Lebrilla, C. B.; Hedrick, J. L. J. Am. Soc. for Mass Spec. “Targeted use of exoglycosidase digestion for the structural elucidation of neutral O-linked oligosaccharides”, 2001, 12 (8), 877-884.
101. Zaia, J. Mass Spectrom Rev “Mass spectrometry of oligosaccharides”, 2004, 23 (3), 161-227.
102. Zaia, J.; Costello, C. E. Anal Chem “Tandem mass spectrometry of sulfated heparin-like glycosaminoglycan oligosaccharides”, 2003, 75 (10), 2445-2455.
103. Zaia, J.; Li, X. Q.; Chan, S. Y.; Costello, C. E. J Am Soc Mass Spectrom “Tandem mass spectrometric strategies for determination of sulfation positions and uronic acid epimerization in chondroitin sulfate oligosaccharides”, 2003, 14 (11), 1270-1281.
104. Zaia, J.; Miller, M. J.; Seymour, J. L.; Costello, C. E. J Am Soc Mass Spectrom “The role of mobile protons in negative ion CID of oligosaccharides”, 2007, 18 (5), 952-960.
105. Zhang, H.; Reinhold, V., Proceedings of 8th Annual Conference of the Society for Glycobiology, “Composition to Sequence: A Novel Computational Approach to Support MSⁿ Carbohydrate Sequencing (Abstract 81)”, San Diego, Calif., USA, Dec. 3-6, 2003.
106. Zhang, H.; Singh, S.; Reinhold, V. Anal. Chem. “Congruent Strategies for Carbohydrate Sequencing: 2. FragLib: An MSⁿ Spectral Library”, 2005, 77 (19), 6263-6270.
107. Zhang, H.; Singh, S.; Reinhold, V., Joint Meeting of The Society for Glycobiology and The Japanese Society for Carbohydrate Research, “Glycan Characterization using a MSⁿ Fragment Fingerprint Library (Abstract 491)”, Honolulu, Hi., Nov. 17-20, 2004.

Other embodiments are within the claims. What is claimed is:

1. A method of glycan sequencing comprising the steps of:
(a) identifying a fragmentation tree of a sample comprising one or more glycans using a stepwise disassembly process;
(b) starting the analysis with a terminus of the fragmentation tree, generating possible substructures represented by an experimentally obtained fragmentation value, and predicting a fragmentation pattern of said substructures;
(c) comparing the experimentally observed fragmentation pattern with the predicted fragmentation pattern;
(d) accepting only candidate structures that correspond sufficiently to the experimental data based on the analysis of (c);
(e) identifying the next member of the fragmentation tree and calculating possible compositions that would correspond to this fragmentation pattern;
(f) growing the candidates structures from step (d) to represent possible substructures matching the compositions identified in step (e);
(g) predicting fragmentation patterns of the candidate structures of step (0; and
(h) repeating steps (c)-(e) on the fragmentation patterns of step (g);
wherein steps (e)-(h) are, optionally, repeated at least once; and
wherein fragmentation patterns are mapped to a precomputed composition database.

2. The method of claim 1, wherein steps (e)-(h) are repeated for all precursor spectra in said fragmentation tree.

3. The method of claim 1, wherein steps (e)-(h) are repeated for a subset of precursor spectra in said fragmentation tree.

4. The method of claim 1, wherein said terminus of the fragmentation tree in (b) is a terminal member, the root member, or an intermediate member.

5.-6. (canceled)

7. The method of claim 4, wherein the possible substructures generated in (b) are all possible substructures.

8. The method of claim 4, wherein the possible substructures generated in (b) are a subset of all possible structures.

9. The method of claim 1, wherein a scoring method is used to determine acceptable candidate structures.

10. The method of claim 9, wherein the scoring method comprises
weighting the bond strengths of bonds ruptured;
favorably weighting high abundance matching peaks in the experimental data and the predicted fragments for the candidate structure;
penalizing a candidate structure if predicted fragments are missing from the experimental data; and
penalizing a candidate structure if predicted fragments appear in the experimental data with significantly lower abundance than expected.

11. The method of claim 1, wherein said stepwise disassembly process comprises sequential mass spectrometry.

12. The method of claim 11, wherein said sequential mass spectrometry uses:
an experimental mode that is positive or negative;
an ionization method selected from electron ionization (EI), electrospray ionization (ESI), matrix-assisted laser desorption/ionization (MALDI), or surface-enhanced laser desorption/ionization (SELDI); and
a dissociation mode selected from collision-induced ionization (CID), in-source fragmentation, infrared multi-photon dissociation (IRMPD), electron capture dissociation (ECD), electron transfer dissociation (ETD), or laser-induced photofragmentation.

13. The method of claim 11, wherein said stepwise disassembly process further comprises the use of at least one glycosidase.

14. The method of claim 13, wherein the stepwise disassembly process comprises
(a) dividing an experimental sample comprising at least one glycan into two or more pools;
(b) selecting one pool prepared in (a);
(c) performing sequential mass spectrometry on the pool of (b);
(d) selecting one pool prepared in (a);
(e) incubating the pool of (d) with a composition comprising at least one glycosidase to yield a digest;
(f) performing tandem or sequential mass spectrometry on the digest of (e); and
(g) comparing the data obtained in (c) and (f);
wherein steps (d)-(g) are repeated for each remaining pool prepared in (a); and
wherein the digest of (e) is optionally purified prior to step (f).

15. (canceled)

16. The method of claim 1, wherein said glycan comprises a
glycoconjugate selected from glycoproteins, glycolipids, and glycosaminoglycans;
N-glycan;
O-glycan;
an oligosaccharide; or
a polysaccharide
or a derivatized form thereof, or any combination thereof.

17.-25. (canceled)

26. A method of detecting glycan isomers using sequential mass spectrometry (MSⁿ) comprising the steps of:
(a) proposing glycan structures for an experimental sample comprising one or more glycans;
(b) comparing the proposed glycan structures of (a) with an MSⁿ spectrum obtained from said experimental sample;
(c) selecting a peak or peaks to be analyzed from the MSⁿ spectrum used in (b);
(d) identifying an extended m/z pathway for each peak identified in (c);
(e) converting each extended m/z pathway of (d) to a feasible composition pathway (FCP);
(f) predicting disassembly patterns of the proposed glycan structures in (a);
(g) comparing the disassembly patterns of (f) to the corresponding FCPs of (e); and
(h) using a scoring method to accept each candidate FCP that meets a threshold of acceptability;
wherein the scoring method of (h) optionally indicates that a glycan from (a) could or could not produce the observed FCP when sequentially disassembled;
wherein said disassembly patterns are mapped to a precomputed composition database.

27. The method of claim 26, wherein the peak selection of (c) is done by a human operator or using a computer algorithm.

28. (canceled)

29. The method of claim 26, wherein the scoring method comprises identifying each FCP as consistent, possibly consistent, or inconsistent with the corresponding m/z pathway.

30. The method of claim 26, wherein the scoring method comprises assigning numerical values to each FCP.

31. (canceled)

32. The method of claim 26, wherein said glycan comprises a
glycoconjugate selected from glycoproteins, glycolipids, and glycosaminoglycans;
N-glycan;
O-glycan; or
an oligosaccharide;
or a derivatized form thereof, or any combination thereof.

33.-37. (canceled)

38. The method of claim 32, wherein said glycan has been cleaved from its glycoconjugate.

39.-41. (canceled)

42. A method of interactively annotating a MSⁿ spectrum of an experimental sample comprising the following steps:
(a) identifying possible compositions corresponding to the precursor ion of a spectrum
(b) comparing a given precursor/product composition pair using the residue counts, residue types, cleavage counts, or cleavage types, or any combination thereof;
(c) based on the comparison of (b), identifying compositions as possibly corresponding to the precursor or not corresponding to the precursor;
(d) optionally eliminating any compositions identified as not corresponding to the precursor in (c);
(e) for each composition eliminated in (c), propagating said elimination to direct or indirect product spectra;
wherein possible compositions that correspond to a precursor are used to annotate a spectrum;
wherein ions that do not satisfy a determined threshold are optionally excluded;
wherein any of the steps (a)-(e), or any combination thereof, may be performed on a precursor more than once; and
wherein steps (a)-(e) are optionally performed on more than one precursor in a spectrum.

43. The method of claim 42, wherein in step (d) compositions identified as not corresponding to the precursor in (c) are eliminated or wherein the ions that do not satisfy a determined threshold are excluded.

44. (canceled)

45. The method of claim 42, wherein said experimental sample comprises a glycan.

46. (canceled)

47. The method of claim 45, wherein said glycan comprises a
glycoconjugate selected from glycoproteins, glycolipids, and glycosaminoglycans;
N-glycan;
O-glycan; or
an oligosaccharide;
or a derivatized form thereof, or any combination thereof.

48.-56. (canceled)

57. The method of claim 16, wherein said derivatized glycan is permethylated.
